(19) United States
(12) Patent Application Publication
(10) Pub. No.: US 2023/0413828 A1
(43) Pub. Date: Dec. 28, 2023

(54) BIOHERBICIDES FOR CONTROLLING ONE OR MORE PLANT SPECIES

(71) Applicants: Joseph FRANK, Charlottesville, VA (US); AGROSPHERES, INC., Charlottesville, VA (US)

(72) Inventors: Joseph FRANK, Charlottesville, VA (US); Ameer Hamza SHAKEEL, Charlottesville, VA (US); Sergio Madrigal CARBALLO, Charlottesville, VA (US); Sepehr ZOMORODI, Charlottesville, VA (US); Payam POURTAHERI, Charlottesville, VA (US)

(21) Appl. No.: 18/037,262

(22) PCT Filed: Nov. 16, 2021
(86) PCT No.: PCT/US2021/059571

§ 371 Date: May 16, 2023

Related U.S. Application Data
(60) Provisional application No. 63/114,831, filed on Nov. 17, 2020.

(51) Int. Cl. A01N 63/20; A01P 13/00; A01N 63/28; A01N 63/22

(52) U.S. Cl. CPC A01N 63/20; A01P 13/00; A01N 63/28; A01N 63/22

(57) ABSTRACT

The present disclosure provides compositions and methods for suppressing growth of various plant species with bioactive agents. Also, the present disclosure provides agricultural compositions and methods of using the formulations containing minicells and bioactive agents for targeted delivery and controlled release to enhance control of various plant species in a stable and scalable manner.

### CROSS-REFERENCE TO RELATED APPLICATIONS

This application claims the benefit of priority to U.S. Provisional Application No. 63/114,831 filed on Nov. 17, 2020, which is hereby incorporated by reference in its entirety.

### FIELD

The present disclosure is generally directed to compositions and formulations of bioactive agents and methods for controlling a target with said bioactive agents. Also disclosed herein are use of a minicell platform for delivering and releasing said bioactive agents to the target in a stable, controlled and scalable manner.

### BACKGROUND

One of the prime concerns for sustainable crop production is weed control. As weeds invade and adapt a wide range of environmental conditions and compete with cultivated plants in an agronomic environment, farmers spend lots of money, time and energy to keep weeds under control and minimize crop yield loss. Also, weeds reduce the aesthetic value, which becomes an issue to home and/or lawn owners.

Despite a variety of physical practices such as coverings, manual removal, tillage, thermal methods for weed control, a chemical method using herbicides remains as a main component of a weed management system.

However, the widespread use of synthetic chemical herbicides that are not naturally occurring compounds has caused societal and environmental concern. The public can be affected by direct contact through spray drift, accidental spills, or indirect contact through consumption of food or water contaminated by herbicides. Also, persistent herbicides can remain active in the environment for long periods of time, potentially causing soil and water contamination and adverse effects to nontarget organisms. The benefits of chemical herbicides must be weighed against the potential for exposure and impacts to human health, nontarget organisms, and the environment as well as the evolution of herbicide resistance within plants.

Thus, naturally occurring products are considered to be more environmental-friendly and less toxic than synthetic pesticides due to their natural origin and low rate of the active ingredient. Accordingly, there is a need for new herbicides with safer toxicological profiles, such as natural herbicides as bioherbicides, which would be nontoxic to the environment, humans and animals. Furthermore, there is an unmet need to develop a new delivery and release system of bioherbicides for sustaining their bioactivity in a stable, controlled and scalable manner.

### SUMMARY OF THE DISCLOSURE

The present disclosure relates to a natural herbicide for controlling or suppressing growth of target plants such as weeds. More particularly, the present disclosure relates to microorganisms and their natural metabolites as bioherbicides for controlling or suppressing growth of target plants. Also, the present disclosure provides an efficient delivery and controlled release of bioherbicides using a minicell technology. It is an object of the disclosure to provide improved bioherbicides and use of a minicell platform for enhancing delivery and release of bioherbicides for better performance in an environmental-friendly manner.

The present disclosure provides for an agricultural composition for controlling growth of one or more plant species comprising: a bioactive agent having herbicidal activity, wherein the bioactive agent is selected from a botanical blend, a metabolite, at least one microbial species, and combinations thereof, and wherein the growth of the plant species is controlled with application of said composition to the plant species. In some embodiments, said botanical blend is a plant extract or oil having a herbicidal activity. In some embodiments, said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound. In some embodiments, said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof. In some embodiments, said microbial species is selected from a Streptomyces genus, an Actinomyces genus, a Bacillus genus and a Pseudomonas genus. In some embodiments, said microbial species is Streptomyces rimosus or Bacillus megaterium. In some embodiments, the composition is applied in a liquid form or a soluble, dry powder form. In some embodiments, an effective amount of the bioactive agent is determined for application of the agricultural composition. In some embodiments, the composition is applied at an effective rate. In some embodiments, the plant species is selected from crabgrass, clover, mustard, wild mustard, dandelion, black medic, bellflower, daisy, plantain, Bermuda grass, blue grass, and Canadian thistle. In some embodiments, the plant species is selected from crabgrass, clover and mustard.

The disclosure also relates to an agricultural composition for controlling growth of one or more plant species comprising: (i) a minicell and (ii) a bioactive agent having herbicidal activity, wherein the bioactive agent is selected from a botanical blend, a metabolite, at least one microbial species, and combinations thereof; and wherein the growth of the plant species is controlled with application of said composition to the plant species. In another embodiment, the minicell is an achromosomal bacterial cell. In another embodiment, the minicell is capable of encapsulating the bioactive agent and wherein the bioactive agent is present within the minicell. In another embodiment, said botanical blend is a plant extract or oil having a herbicidal activity. In another embodiment, said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound. In another embodiment, said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof. In another embodiment, said microbial species is selected from a Streptomyces genus, an Actinomyces genus, a Bacillus genus and a Pseudomonas genus. In another embodiment, said microbial species is Streptomyces rimosus or Bacillus megaterium. In another embodiment, the composition is applied in a liquid form or a soluble, dry powder form. In another embodiment, an effective amount of the bioactive agent is determined for application of the agricultural composition. In another embodiment, the composition is applied at an effective rate. In another embodiment, a mixture ratio of the bioactive agent and the minicell is from 1:4 to 4:1 in volume to volume. In another embodiment, the plant species is selected from crabgrass, clover, mustard, wild mustard, dandelion, black medic, bellflower, daisy, plantain, Bermuda grass, blue grass, and Canadian thistle. In another embodiment, the plant species is selected from crabgrass, clover and mustard. In another embodiment, the bioactive agent in the presence of the minicell has at least 5% higher herbicidal activity than the bioactive agent alone over a week after treatment.

The disclosure further relates to a method of controlling growth of one or more plant species, the method comprising: applying an effective amount of an agricultural composition to a plant or a part thereof, wherein said composition comprises a bioactive agent having herbicidal activity, wherein the bioactive agent is selected from a botanical blend, a metabolite, at least one microbial species, and combinations thereof, and wherein the growth of the plant species is controlled with said application of the composition. In other embodiments, said composition is applied to any portion of said plant or said part thereof. In other embodiments, said composition is applied to a root system of said plant or said part thereof. In other embodiments, said botanical blend is a plant extract or oil having a herbicidal activity. In other embodiments, said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound. In other embodiments, said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof. In other embodiments, said microbial species is selected from a Streptomyces genus, an Actinomyces genus, a Bacillus genus and a Pseudomonas genus. In other embodiments, said microbial species is Streptomyces rimosus or Bacillus megaterium. In other embodiments, the composition is applied in a liquid form or a soluble, dry powder form. In other embodiments, an effective amount of the bioactive agent is determined for application of the agricultural composition. In other embodiments, the composition is applied at an effective rate. In other embodiments, the plant species is selected from crabgrass, clover, mustard, wild mustard, dandelion, black medic, bellflower, daisy, plantain, Bermuda grass, blue grass, and Canadian thistle. In other embodiments, the plant species is selected from crabgrass, clover and mustard.

In other embodiments, the disclosure provides for a method of controlling growth of one or more plant species, the method comprising: applying an effective amount of an agricultural composition for controlling growth of one or more plant species comprising: (i) a minicell and (ii) a bioactive agent having herbicidal activity, wherein the bioactive agent is selected from a botanical blend, a metabolite, at least one microbial species, and combinations thereof; and wherein the growth of the plant species is controlled with said application of the composition. In other embodiments, the minicell is an achromosomal bacterial cell. In other embodiments, the minicell is capable of encapsulating the bioactive agent and wherein the bioactive agent is present within the minicell. In other embodiments, said composition is applied to any portion of said plant or said part thereof. In other embodiments, said composition is applied to a root system of said plant or said part thereof. In other embodiments, said botanical blend is a plant extract or oil having a herbicidal activity. In other embodiments, said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound. In other embodiments, said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof. In other embodiments, said microbial species is selected from a Streptomyces genus, an Actinomyces genus, a Bacillus genus and a Pseudomonas genus. In other embodiments, said microbial species is Streptomyces rimosus or Bacillus megaterium. In other embodiments, the composition is applied in a liquid form or a soluble, dry powder form. In other embodiments, an effective amount of the bioactive agent is determined for application of the agricultural composition. In other embodiments, the composition is applied at an effective rate. In other embodiments, a mixture ratio of the bioactive agent and the minicell is from 1:4 to 4:1 in volume to volume. In other embodiments, the plant species is selected from crabgrass, clover, mustard, wild mustard, dandelion, black medic, bellflower, daisy, plantain, Bermuda grass, blue grass, and Canadian thistle. In other embodiments, the plant species is selected from crabgrass, clover and mustard. In another embodiment, the bioactive agent in the presence of the minicell has at least 5% higher herbicidal activity than the bioactive agent alone over a week after treatment.

### BRIEF DESCRIPTION OF THE FIGURES

FIG. 1 illustrates evaluation of loading capacities for minicell (AgriCell; AC) loaded with Agro Gold (AG; Part B of Weed Slayer) solution (100%) as a function of volume ratio (1:1, Vol/Vol).

FIG. 2 illustrates AG release profile in AG alone (AG,) and AG-loaded AC (AC-AG, O).

FIG. 3 illustrates herbicidal effect of Part A (Weed Slayer; WS), Part B (Agro Gold; AG), and a mixture of Parts A and B (WS+AG) on crabgrass and clover. Field plots (3.5′×16′) infested mostly with crabgrass and clover in St. Louis, MO were used for this herbicidal test with three treatments (WS alone; AG alone; and 1:1 v/v ratio of WS/AG mixture) in triplicate. The left panels show the plot treated/sprayed with 1× concentration of WS at 8, 15, and 31 days after treatment (DAT). The middle panels show the plot treated/sprayed with a mixture of 1× concentration of WS and 1× concentration of AG at 8, 15, and 31 DAT. The right panels show the plot treated/sprayed with Ix concentration of AG at 8, 15, and 31 DAT.

FIG. 4 illustrates efficacy of WS alone, AG alone, and WS/AG mixture for controlling crabgrass and clover. In FIG. 4, the herbicidal effect displayed in FIG. 3 is quantified and presented with percentage of controlled growth of crabgrass and clover in the tested plots at 8, 15, and 31 days after treatment (DAT).

FIG. 5 illustrates herbicidal effect of WS, AG, WS+AG, and a mixture of AG with minicell (AgriCell; AC) on crabgrass. Another field test was performed in plots (1.75′×8′) infested with crabgrass in St. Louis, MO. The test was designed for four treatments (WS alone; 1:1 v/v ratio of WS/AG mixture; AG alone; and 1:1 v/v ratio of AG/AC mixture) in triplicate. The first panels show the plot treated/sprayed with 1× concentration of WS at 6 and 15 DAT. The second panels show the plottreated/sprayed with a mixture of 1× concentration of WS and 1× concentration of AG (WS+AG) at 6 and 15 DAT. The third panels show the plot treated/sprayed with 1× concentration of AG at 6 and 15 DAT. The last panels show the plot treated/sprayed with a mixture of 1× concentration of AG and 1× concentration of AC (AG+AC) at 6 and 15 DAT.

FIG. 6 illustrates efficacy of WS alone, AG alone, WS/AG mixture, and AG/AC mixture for controlling crabgrass. In FIG. 6, the herbicidal effect displayed in FIG. 5 is quantified and presented with percentage of controlled growth of crabgrass in the tested plots at 6 and 15 DAT.

FIGS. 7A-7B illustrate herbicidal effect of WS, AG, WS+AG, AG+AC, and a mixture of Eugenol with AC (AC+Eug) on mustard grass. A green house test was performed in plots (3″×9″) infested with mustard grass in St. Louis, MO. Six treatments (Negative Control; WS alone; 1:1 ratio of WS/AG mixture; AG alone; 1:1 v/v ratio of AG/AC mixture; 1:1 v/v ratio of AC/Eugenol mixture) were made in triplicate. FIG. 7A shows the test plots treated/sprayed with six treatments described above at 4 DAT (left panel) and 8 DAT (right panel). FIG. 7B shows the test plots treated/sprayed with the same treatments as FIG. 7A, instead, at 15 DAT.

FIG. 8 illustrates efficacy of negative control, WS alone, AG alone, WS/AG mixture, AG/AC mixture, and AC/Eug mixture for controlling mustard grass. In FIG. 8, the herbicidal effect displayed in FIGS. 7A-7B are quantified and presented with percentage of controlled growth of mustard grass in the tested plots at 4, 8, and 15 days after treatment (DAT).

### DETAILED DESCRIPTION

The present disclosure relates generally to use of microbial strains and their natural products that have bioactive herbicidal activity for controlling weeds and application of a minicell platform to microbial natural products for enhancing their value, effect and/or activity for bioactive weed control.

The present disclosure is generally directed to an agricultural composition comprising an bioactive agent including botanical blends, metabolites, and a plurality of microbial species as well as an agricultural composition comprising a minicell and a bioactive agent taught herein. Also, disclosed are methods of controlling or suppressing growth of undesirable plant species using an agricultural composition or formulation taught herein.

### Definitions

While the following terms are believed to be well understood by one of ordinary skill in the art, the following definitions are set forth to facilitate explanation of the presently disclosed subject matter.

The term “a” or “an” refers to one or more of that entity, i.e. can refer to a plural referents. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

As used herein, “industrially suitable” refers to utilization, and applications, of the achromosomal/anucleated cell-based delivery platform, in contexts outside of internally administered animal host applications, e.g. outside of administered human therapeutics.

The term “a bioactive agent,” (synonymous with “a biologically active agent”) indicates that a composition or compound itself has a biological effect, or that it modifies, causes, promotes, enhances, blocks, reduces, limits the production or activity of, or reacts with or binds to an endogenous molecule that has a biological effect. A “biological effect” may be but is not limited to one that impacts a biological process in/onto a plant; one that impacts a biological process in and/or onto a pest, pathogen or parasite. A bioactive agent may be used in agricultural applications. A biological agent acts to cause or stimulate a desired effect upon a plant, an insect, a worm, bacteria, fungi, or virus. Non-limiting examples of desired effects include, for example, (i) suppressing, inhibiting, limiting, or controlling growth of or killing one or more plant species such as undesirable weeds, (ii) preventing, treating or curing a disease or condition in a plant suffering therefrom; (iii) suppressing, inhibiting, limiting, or controlling growth of or killing a pest, a pathogen or a parasite that infects a plant; (iv) augmenting the phenotype or genotype of a plant; (v) stimulating a positive response in one or more plant species, such as desirable plants, to germinate, grow vegetatively, bloom, fertilize, produce fruits and/or seeds, and harvest; (vi) controlling a pest to cause a disease or disorder.

The term, “target plant” refers to a plant for which growth is not desired and which is susceptible to the effects of a natural herbicide or a bioherbicide, exhibiting, for example, reduced growth, abnormal development or death when exposed to the natural herbicide or the bioherbicide. Target plants are typically annual and perennial weed species. Non-limiting examples of weeds include, but not limited to, crabgrass (Digitaria spp.), mustard (Brassica juncea), wild mustard (Sinapis arvensis), dandelion (Taraxacum officinale), white clover (Trifolium repens), black medic (Medicago lupulina), bellflower (Companula rapunculoides), English daisy (Bellis perennis), plantain (Plantago spp.), Bermuda grass (Cynodon dactylon), annual blue grass (Poa annua), oxeye daisy (Chrysanthemum leucanthemum) and Canadian thistle (Circium arvense).

As used herein the terms “cellular organism,” “microorganism” or “microbe” should be taken broadly. These terms are used interchangeably and include, but are not limited to, the two prokaryotic domains, Bacteria and Archaea, as well as certain eukaryotic fungi and protists.

The term “prokaryotes” refers to cells that contain no nucleus or other cell organelles. The prokaryotes are generally classified in one of two domains, the Bacteria and the Archaea. The definitive difference between organisms of the Archaea and Bacteria domains is based on fundamental differences in the nucleotide base sequence in the 16S ribosomal RNA.

The term “Archaea” refers to a categorization of organisms of the division Mendosicutes, typically found in unusual environments and distinguished from the rest of the prokaryotes by several criteria, including the number of ribosomal proteins and the lack of muramic acid in cell walls. On the basis of ssrRNA analysis, the Archaea consist of two phylogenetically-distinct groups: Crenarchaeota and Euryarchaeota. On the basis of their physiology, the Archaea can be organized into three types: methanogens (prokaryotes that produce methane); extreme halophiles (prokaryotes that live at very high concentrations of salt (NaCl); and extreme (hyper) thermophilus (prokaryotes that live at very high temperatures). Besides the unifying archaeal features that distinguish them from Bacteria (i.e., no murein in cell wall, ester-linked membrane lipids, etc.), these prokaryotes exhibit unique structural or biochemical attributes which adapt them to their particular habitats. The Crenarchaeota consists mainly of hyperthermophilic sulfur-dependent prokaryotes and the Euryarchaeota contains the methanogens and extreme halophiles.

“Bacteria” or “eubacteria” refers to a domain of prokaryotic organisms. Bacteria include at least 11 distinct groups as follows: (1) Gram-positive (gram+) bacteria, of which there are two major subdivisions: (1) high G+C group (Actinomycetes, Mycobacteria, Micrococcus, others) (2) low G+C group (Bacillus, Clostridia, Lactobacillus, Staphylococci, Streptococci, Mycoplasmas); (2) Proteobacteria, e.g., Purple photosynthetic+non-photosynthetic Gram-negative bacteria (includes most “common” Gram-negative bacteria); (3) Cyanobacteria, e.g., oxygenic phototrophs; (4) Spirochetes and related species; (5) Planctomyces; (6) Bacteroides, Flavobacteria; (7) Chlamydia; (8) Green sulfur bacteria; (9) Green non-sulfur bacteria (also anaerobic phototrophs); (10) Radioresistant micrococci and relatives; (11) Thermotoga and Thermosipho thermophiles.

A “eukaryote” is any organism whose cells contain a nucleus and other organelles enclosed within membranes. Eukaryotes belong to the taxon Eukarya or Eukaryota. The defining feature that sets eukaryotic cells apart from prokaryotic cells (the aforementioned Bacteria and Archaea) is that they have membrane-bound organelles, especially the nucleus, which contains the genetic material, and is enclosed by the nuclear envelope.

The terms “genetically modified host cell,” “recombinant host cell,” and “recombinant strain” are used interchangeably herein and refer to host cells that have been genetically modified by the cloning and transformation methods of the present disclosure or known in the art. Thus, the terms include a host cell (e.g., bacteria, yeast cell, fungal cell, CHO, human cell, etc.) that has been genetically altered, modified, or engineered, such that it exhibits an altered, modified, or different genotype and/or phenotype (e.g., when the genetic modification affects coding nucleic acid sequences of the microorganism), as compared to the naturally-occurring organism from which it was derived. It is understood that in some embodiments, the terms refer not only to the particular recombinant host cell in question, but also to the progeny or potential progeny of such a host cell.

The term “wild-type microorganism” or “wild-type host cell” describes a cell that occurs in nature, i.e. a cell that has not been genetically modified. In the disclosure, “wild type strain” or “wild strain” or “wild type cell line” refers to a cell strain/line that can produce achromosomal cells such as minicells. In some embodiments, wild type bacterial strains and/or cell lines such as E. coli strain p678-54 and B. subtilis strain CU403 can make miniature cells deficient in DNA. Methods for producing such minicells are known in the art. See, for example, Adler et al., 1967, Proc. Natl. Acad Sci. USA 57:321-326; Inselburg J, 1970 J Bacteriol. 102(3):642-647; Frazer 1975, Curr. Topics Microbiol. Immunol. 69:1-84, Reeve et al 1973, J. Bacteriol. 114(2):860-873; and Mendelson et al 1974 J. Bacteriol. 117(3):1312-1319.

The term “genetically engineered” may refer to any manipulation of a host cell's genome (e.g. by insertion, deletion, mutation, or replacement of nucleic acids).

The term “control host cell” refers to an appropriate comparator host cell for determining the effect of a genetic modification or experimental treatment. In some embodiments, the control host cell is a wild type cell. In other embodiments, a control host cell is genetically identical to the genetically modified host cell, save for the genetic modification(s) differentiating the treatment host cell.

As used herein, the term “genetically linked” refers to two or more traits that are co-inherited at a high rate during breeding such that they are difficult to separate through crossing.

A “recombination” or “recombination event” as used herein refers to a chromosomal crossing over or independent assortment.

As used herein, the term “phenotype” refers to the observable characteristics of an individual cell, cell culture, organism, or group of organisms which results from the interaction between that individual's genetic makeup (i.e., genotype) and the environment.

As used herein, the term “chimeric” or “recombinant” when describing a nucleic acid sequence or a protein sequence refers to a nucleic acid, or a protein sequence, that links at least two heterologous polynucleotides, or two heterologous polypeptides, into a single macromolecule, or that rearranges one or more elements of at least one natural nucleic acid or protein sequence. For example, the term “recombinant” can refer to an artificial combination of two otherwise separated segments of sequence, e.g., by chemical synthesis or by the manipulation of isolated segments of nucleic acids by genetic engineering techniques.

As used herein, a “synthetic nucleotide sequence” or “synthetic polynucleotide sequence” is a nucleotide sequence that is not known to occur in nature or that is not naturally occurring. Generally, such a synthetic nucleotide sequence will comprise at least one nucleotide difference when compared to any other naturally occurring nucleotide sequence.

As used herein, a “synthetic amino acid sequence” or “synthetic peptide” or “synthetic protein” is an amino acid sequence that is not known to occur in nature or that is not naturally occurring. Generally, such a synthetic protein sequence will comprise at least one amino acid difference when compared to any other naturally occurring protein sequence.

As used herein, the term “nucleic acid” refers to a polymeric form of nucleotides of any length, either ribonucleotides or deoxyribonucleotides, or analogs thereof. This term refers to the primary structure of the molecule, and thus includes double- and single-stranded DNA, as well as double- and single-stranded RNA. It also includes modified nucleic acids such as methylated and/or capped nucleic acids, nucleic acids containing modified bases, backbone modifications, and the like. The terms “nucleic acid” and “nucleotide sequence” are used interchangeably.

As used herein, the term “gene” refers to any segment of DNA associated with a biological function. Thus, genes include, but are not limited to, coding sequences and/or the regulatory sequences required for their expression. Genes can also include non-expressed DNA segments that, for example, form recognition sequences for other proteins. Genes can be obtained from a variety of sources, including cloning from a source of interest or synthesizing from known or predicted sequence information, and may include sequences designed to have desired parameters.

As used herein, the term “homologous” or “homologue” or “ortholog” is known in the art and refers to related sequences that share a common ancestor or family member and are determined based on the degree of sequence identity. The terms “homology,” “homologous,” “substantially similar” and “corresponding substantially” are used interchangeably herein. They refer to nucleic acid fragments wherein changes in one or more nucleotide bases do not affect the ability of the nucleic acid fragment to mediate gene expression or produce a certain phenotype. These terms also refer to modifications of the nucleic acid fragments of the instant disclosure such as deletion or insertion of one or more nucleotides that do not substantially alter the functional properties of the resulting nucleic acid fragment relative to the initial, unmodified fragment. It is therefore understood, as those skilled in the art will appreciate, that the disclosure encompasses more than the specific exemplary sequences. These terms describe the relationship between a gene found in one species, subspecies, variety, cultivar or strain and the corresponding or equivalent gene in another species, subspecies, variety, cultivar or strain. For purposes of this disclosure homologous sequences are compared. “Homologous sequences” or “homologues” or “orthologs” are thought, believed, or known to be functionally related. A functional relationship may be indicated in any one of a number of ways, including, but not limited to: (a) degree of sequence identity and/or (b) the same or similar biological function. Preferably, both (a) and (b) are indicated. Homology can be determined using software programs readily available in the art, such as those discussed in Current Protocols in Molecular Biology (F. M. Ausubel et al., eds., 1987) Supplement 30, section 7.718, Table 7.71. Some alignment programs are MacVector (Oxford Molecular Ltd, Oxford, U.K.), ALIGN Plus (Scientific and Educational Software, Pennsylvania) and AlignX (Vector NTI, Invitrogen, Carlsbad, CA). Another alignment program is Sequencher (Gene Codes, Ann Arbor, Michigan), using default parameters.

As used herein, the term “endogenous” or “endogenous gene,” refers to the naturally occurring gene, in the location in which it is naturally found within the host cell genome. In the context of the present disclosure, operably linking a heterologous promoter to an endogenous gene means genetically inserting a heterologous promoter sequence in front of an existing gene, in the location where that gene is naturally present. An endogenous gene as described herein can include alleles of naturally occurring genes that have been mutated according to any of the methods of the present disclosure.

As used herein, the term “exogenous” is used interchangeably with the term “heterologous,” and refers to a substance coming from some source other than its native source. For example, the terms “exogenous protein,” or “exogenous gene” refer to a protein or gene from a non-native source or location, and that have been artificially supplied to a biological system.

As used herein, the term “nucleotide change” refers to, e.g., nucleotide substitution, deletion, and/or insertion, as is well understood in the art. For example, mutations contain alterations that produce silent substitutions, additions, or deletions, but do not alter the properties or activities of the encoded protein or how the proteins are made.

As used herein, the term “protein modification” refers to, e.g., amino acid substitution, amino acid modification, deletion, and/or insertion, as is well understood in the art.

As used herein, the term “at least a portion” or “fragment” of a nucleic acid or polypeptide means a portion having the minimal size characteristics of such sequences, or any larger fragment of the full length molecule, up to and including the full length molecule. A fragment of a polynucleotide of the disclosure may encode an enzymatically active portion of a genetic regulatory element. An enzymatically active portion of a genetic regulatory element can be prepared by isolating a portion of one of the polynucleotides of the disclosure that comprises the genetic regulatory element and assessing activity as described herein. Similarly, a portion of a polypeptide may be 4 amino acids, 5 amino acids, 6 amino acids, 7 amino acids, and so on, going up to the full length polypeptide. The length of the portion to be used will depend on the particular application. A portion of a nucleic acid useful as a hybridization probe may be as short as 12 nucleotides; in some embodiments, it is 20 nucleotides. A portion of a polypeptide useful as an epitope may be as short as 4 amino acids. A portion of a polypeptide that performs the function of the full-length polypeptide would generally be longer than 4 amino acids.

Variant polynucleotides also encompass sequences derived from a mutagenic and recombinogenic procedure such as DNA shuffling. Strategies for such DNA shuffling are known in the art. See, for example, Stemmer (1994) PNAS 91:10747-10751; Stemmer (1994) Nature 370:389-391; Crameri et al. (1997) Nature Biotech. 15:436-438; Moore et al. (1997) J. Mol. Biol. 272:336-347; Zhang et al. (1997) PNAS 94:4504-4509; Crameri et al. (1998) Nature 391:288-291; and U.S. Pat. Nos. 5,605,793 and 5,837,458.

For PCR amplifications of the polynucleotides disclosed herein, oligonucleotide primers can be designed for use in PCR reactions to amplify corresponding DNA sequences from cDNA or genomic DNA extracted from any organism of interest. Methods for designing PCR primers and PCR cloning are generally known in the art and are disclosed in Sambrook et al. (2001) Molecular Cloning: A Laboratory Manual (3^{rd} ed., Cold Spring Harbor Laboratory Press, Plainview, New York). See also Innis et al., eds. (1990) PCR Protocols: A Guide to Methods and Applications (Academic Press, New York); Innis and Gelfand, eds. (1995) PCR Strategies (Academic Press, New York); and Innis and Gelfand, eds. (1999) PCR Methods Manual (Academic Press, New York). Known methods of PCR include, but are not limited to, methods using paired primers, nested primers, single specific primers, degenerate primers, gene-specific primers, vector-specific primers, partially-mismatched primers, and the like.

The term “primer” as used herein refers to an oligonucleotide which is capable of annealing to the amplification target allowing a DNA polymerase to attach, thereby serving as a point of initiation of DNA synthesis when placed under conditions in which synthesis of primer extension product is induced, i.e., in the presence of nucleotides and an agent for polymerization such as DNA polymerase and at a suitable temperature and pH. The (amplification) primer is preferably single stranded for maximum efficiency in amplification. Preferably, the primer is an oligodeoxyribonucleotide. The primer must be sufficiently long to prime the synthesis of extension products in the presence of the agent for polymerization. The exact lengths of the primers will depend on many factors, including temperature and composition (A/T vs. G/C content) of primer. A pair of bi-directional primers consists of one forward and one reverse primer as commonly used in the art of DNA amplification such as in PCR amplification.

As used herein, “promoter” refers to a DNA sequence capable of controlling the expression of a coding sequence or functional RNA. In some embodiments, the promoter sequence consists of proximal and more distal upstream elements, the latter elements often referred to as enhancers. Accordingly, an “enhancer” is a DNA sequence that can stimulate promoter activity, and may be an innate element of the promoter or a heterologous element inserted to enhance the level or tissue specificity of a promoter. Promoters may be derived in their entirety from a native gene, or be composed of different elements derived from different promoters found in nature, or even comprise synthetic DNA segments. It is understood by those skilled in the art that different promoters may direct the expression of a gene in different tissues or cell types, or at different stages of development, or in response to different environmental conditions. It is further recognized that since in most cases the exact boundaries of regulatory sequences have not been completely defined, DNA fragments of some variation may have identical promoter activity.

As used herein, the phrases “recombinant construct”, “expression construct”, “chimeric construct”, “construct”, and “recombinant DNA construct” are used interchangeably herein. Also, “construct”, “vector”, and “plasmid” are used interchangeably herein. A recombinant construct comprises an artificial combination of nucleic acid fragments, e.g., regulatory and coding sequences that are not found together in nature. For example, a chimeric construct may comprise regulatory sequences and coding sequences that are derived from different sources, or regulatory sequences and coding sequences derived from the same source, but arranged in a manner different than that found in nature. Such construct may be used by itself or may be used in conjunction with a vector. If a vector is used then the choice of vector is dependent upon the method that will be used to transform host cells. For example, a plasmid vector can be used. The skilled artisan is well aware of the genetic elements that must be present on the vector in order to successfully transform, select and propagate host cells comprising any of the isolated nucleic acid fragments of the disclosure. The skilled artisan will also recognize that different independent transformation events will result in different levels and patterns of expression (Jones et al., (1985) EMBO J. 4:2411-2418; De Almeida et al., (1989) Mol. Gen. Genetics 218:78-86), and thus that multiple events must be screened in order to obtain lines displaying the desired expression level and pattern. Such screening may be accomplished by Southern analysis of DNA, Northern analysis of mRNA expression, immunoblotting analysis of protein expression, or phenotypic analysis, among others. Vectors can be plasmids, viruses, bacteriophages, pro-viruses, phagemids, transposons, artificial chromosomes, and the like, that replicate autonomously or can integrate into a chromosome of a host cell. A vector can also be a naked RNA polynucleotide, a naked DNA polynucleotide, a polynucleotide composed of both DNA and RNA within the same strand, a poly-lysine-conjugated DNA or RNA, a peptide-conjugated DNA or RNA, a liposome-conjugated DNA, or the like, that is not autonomously replicating. As used herein, the term “expression” refers to the production of a functional end-product e.g., an mRNA or a protein (precursor or mature).

“Operably linked” means in this context the sequential arrangement of the promoter polynucleotide according to the disclosure with a further oligo- or polynucleotide, resulting in transcription of said further polynucleotide.

As used herein, the term “display” refers to the exposure of the polypeptide of interest on the outer surface of the minicell. By way of non-limiting example, the displayed polypeptide may be a protein or a protein domain which is either expressed on the minicell membrane or is associated with the minicell membrane such that the extracellular domain or domain of interest is exposed on the outer surface of the minicell (expressed and displayed on the surface of the minicell or expressed in the parental cell to be displayed on the surface of the segregated/budded minicell). In all instances, the “displayed” protein or protein domain is available for interaction with extracellular components. A membrane-associated protein may have more than one extracellular domain, and a minicell of the disclosure may display more than one membrane-associated protein.

As used herein, the terms “polypeptide”, “protein” and “protein domain” refer to a macromolecule made up of a single chain of amino acids joined by peptide bonds. Polypeptides of the invention may comprise naturally occurring amino acids, synthetic amino acids, genetically encoded amino acids, non-genetically encoded amino acids, and combinations thereof. Polypeptides may include both L-form and D-form amino acids.

As used herein, the term “enzymatically active polypeptide” refers to a polypeptide which encodes an enzymatically functional protein. The term “enzymatically active polypeptide” includes but not limited to fusion proteins which perform a biological function. Exemplary enzymatically active polypeptides, include but not limited to enzymes/enzyme moiety (e.g. wild type, variants, or engineered variants) that specifically bind to certain receptors or biological/chemical substrates to effect a biological function such as biological signal transduction or chemical inactivation.

As used herein, the term “protease-deficient strain” refers to a strain that is deficient in one or more endogenous proteases. For example, protease deficiency can be created by deleting, removing, knock-out, silencing, suppressing, or otherwise downregulating at lease on endogenous protease. Said proteases can include catastrophic proteases. For example, BL21 (DE3) E. coli strain is deficient in proteases Lon and OmpT. E. coli strain has cytoplasmic proteases and membrane proteases that can significantly decrease protein production and localization to the membrane. In some embodiments, a protease-deficient strain can maximize production and localization of a protein of interest to the membrane of the cell. “Protease-deficient” can be interchangeably used as “protease-free” in the present disclosure.

As used herein, the term “ribonuclease-deficient strain” refers to a strain that is deficient in one or more endogenous ribonuclease. For example, ribonuclease deficiency can be created by deleting, removing, knock-out, silencing, suppressing, or otherwise downregulating at lease on endogenous ribonuclease. Said ribonuclease can include ribonuclease III. For example, HT115 E. coli strain is deficient in RNase III. In some embodiments, a ribonuclease-deficient strain is unable to and/or has a reduced capability of recognizing dsRNA and cleaving it at specific targeted locations. “Ribonuclease-deficient” can be interchangeably used as “ribonuclease-free” in the present disclosure.

As used herein, the term “anucleated cell” refers to a cell that lacks a nucleus and also lacks chromosomal DNA and which can also be termed as an “anucleate cell”. Because eubacterial and archaebacterial cells, unlike eukaryotic cells, naturally do not have a nucleus (a distinct organelle that contains chromosomes), these non-eukaryotic cells are of course more accurately described as being “without chromosomes” or “achromosomal.” Nonetheless, those skilled in the art often use the term “anucleated” when referring to bacterial minicells in addition to other eukaryotic minicells. Accordingly, in the present disclosure, the term “minicells” encompasses derivatives of eubacterial cells that lack a chromosome; derivatives of archaebacterial cells that lack their chromosome(s), and anucleate derivatives of eukaryotic cells that lack a nucleus and consequently a chromosome. Thus, in the present disclosure, “anucleated cell” or “anucleate cell” can be interchangeably used with the term “achromosomal cell.”

As used herein, the term “binding site,” means a molecular structure or compound, such as a protein, a polypeptide, a polysaccharide, a glycoprotein, a lipoprotein, a fatty acid, a lipid or a nucleic acid or a particular region in such molecular structure or compound or a particular conformation of such molecular structure or compound, or a combination or complex of such molecular structures or compounds. In certain embodiments, at least one binding site is on an intact living plant. An “intact living plant,” as used herein, means a plant as it grows, whether it grows in soil, in water or in artificial substrate, and whether it grows in the field, in a greenhouse, in a yard, in a garden, in a pot or in hydroponic culture systems. An intact living plant preferably comprises all plant parts (roots, stem, branches, leaves, needles, thorns, flowers, seeds etc.) that are normally present on such plant in nature, although some plant parts, such as, e.g., flowers, may be absent during certain periods in the plant's life cycle.

A “binding domain,” as used herein, means the whole or part of a proteinaceous (protein, protein-like or protein containing) molecule that is capable of binding using specific intermolecular interactions to a target molecule. A binding domain can be a naturally occurring molecule, it can be derived from a naturally occurring molecule, or it can be entirely artificially designed. A binding domain can be based on domains present in proteins, including but not limited to microbial proteins, protease inhibitors, toxins, fibronectin, lipocalins, single-chain antiparallel coiled coil proteins or repeat motif proteins. Non-limiting examples of such binding domains are carbohydrate binding modules (CBM) such as cellulose binding domain to be targeted to plants. In some embodiments, a cell adhesion moiety comprises a binding domain.

As used herein, “carrier,” “acceptable carrier,” or “biologically actively acceptable carrier” refers to a diluent, adjuvant, excipient, or vehicle with which a composition can be administered to its target, which does not detrimentally effect the composition.

In some embodiments, biologically active agents can be used as bioherbicides that have become the new age of crop protection and enhancement by negatively controlling undesired plant species, such weeds.

In some embodiments, the present disclosure provides an industrially suitable anucleated cell-based platform and/or an agricultural formulation that can deliver bioherbicides topically in a scalable, stable, and controlled manner by using the anucleated cell-based platform and/or an agricultural formulation described herein. This anucleated cell-based platform and/or an agricultural formulation can also be modified to invasively deliver bioherbicides to plants.

The present disclosure teaches that an industrially suitable anucleated cell-based platform and/or an agricultural formulation for encapsulation and delivery of at least one biologically active agent, comprising: an intact anucleated cell derived from a parental cell, comprising at least one biologically active agent encapsulated by said cell, wherein said biologically active agent is a microbe or a metabolite, wherein the microbial strain or the metabolite thereof targets a target plant, a part thereof, and a cell thereof. The anucleated cell-based platform and/or an agricultural formulation further comprises at least one biologically acceptable carrier.

In some embodiments, for protein-mediated bioherbicides, the present disclosure uses bacterial cells lacking proteases and has T7, T3, or Sp6 polymerase promoters to produce a significant amount of proteins. This bacterial cell is then modified to produce minicells with the proteins immobilized to their surface or encapsulated within them. A protein-expressing plasmid is integrated into the nucleoid DNA of the bacteria to safely and efficiently produce proteins. Insects then interact with or orally consume the minicells that express or retain the desired proteins. For antibody-mediated biocontrols, minicells can express or encapsulate antibodies to specifically target unwanted pests. Minicells can deliver antibodies or recombinant antibodies that serve as highly specific biopesticides against insects or fungal pathogens (Raymond et al., Fungal Biology Review 25(2) 0.84-88, 2011).

In some embodiments, for bioherbicides, the present disclosure teaches that minicells can deliver a wide range of plant-growth suppressing biomolecules/agents to the surface of the plant, its seeds, and its root system. Many of these biomolecules occur as a result of a dynamic relationship that some microorganisms have with plants and are produced naturally in response to certain environmental cues or stresses. The minicell can be engineered to deliver a high-payload capacity of these plant growth suppressing biomolecules/agents, either immobilized extracellularly on their surface or encapsulated intracellularly, without relying on microorganism or plants to naturally produce them. This enables a higher effective concentration of these biomolecules/agents to be delivered to the plant and/or plant microenvironment while also allowing for a more controlled, adaptive response to agricultural input needs.

In some embodiments, the biologically active agents are primary metabolites and secondary metabolites from microbes that could be delivered to the plant or its root system using the minicell, which include, but are not limited to amino acids, peptides, nucleosides and analogues, acyclic and cyclic esters, organic acids, amides (not peptides), ozazole-containing metabolites, antraquinones and ansamycins, and non-classified herbicidal compounds.

Beyond being able to effectively deliver enzymes to promote the growth of plants, the minicell described herein can deliver other high-value biomolecules that play a role in promoting the growth of plants. These biomolecules include, but are not limited to plant hormones, such as the auxin IAA, peptides, primary metabolites, and secondary metabolites.

In other embodiments, the delivery of bioherbicides can be assisted through binding domains expressed on a surface of minicells. For example, minicells can express a binding domain such as a carbohydrate binding module (CBM) to be targeted to plants. These domains allow for better retention on plant surfaces, preventing runoff or drift. In some embodiments, minicells express a fusion protein comprising at least one surface expressing moiety and at least one target cell adhesion moiety, wherein said target cell adhesion moiety comprises a carbohydrate binding module. The target cell adhesion moiety comprises a carbohydrate binding module selected from the group consisting of: a cellulose binding domain, a xylan binding domain, a chitin binding domain, and a lignin binding domain.

In other embodiments, minicells can also express various proteins that encourage them to be uptaken by plants for invasive delivery through the leaf surface or roots. In some embodiments, minicells can express and display biologically active compound such as polypeptide and/or proteins on their surface. In other embodiments, minicells can express and display both surface expressed binding proteins and biologically active compound such as polypeptide and/or proteins on their surface.

The surface expressed binding proteins are as a carbohydrate binding module (CBM) described above. The biologically/enzymatically active polypeptide/proteins, which are surface-expressed, comprise cell stimulation moiety and/or cell degradation moiety. Non-limiting examples of such active proteins include, but are not limited to, ACC-deaminase, chitinase, cellulase, phytase, chitinase, protease, phosphatase, nucleases, lipases, glucanases, xylanases, amylases, peptidases, peroxidases, ligninases, pectinases, hemicellulases, and keratinases.

In some embodiments, a biologically active/bioactive agent taught herein can be expressed/produced exogenously and encapsulated into minicells taught herein. The biologically active agent are either encapsulated within the minicells after being expressed outside of the minicells or internally expressed/produced within the minicells. In further embodiments, the minicells express at least one biologically active compound such as polypeptides/proteins on its surface and encapsulate another biologically active agent such as a bioherbicide at the same time. So, the minicell can carry at least two biologically active compounds within the minicells and on the surface of the minicells. Non-limiting examples of such polypeptides/proteins on the surface include, but are not limited to ACC-deaminase, cellulase, phytase, chitinase, protease, phosphatase, nucleases, lipases, glucanases, xylanases, amylases, peptidases, peroxidases, ligninases, pectinases, hemicellulases, and keratinases.

The present disclosure teaches production and encapsulation of bioherbicides, which are a plurality of microbial species and metabolites produced from the microbial species. Non-limiting examples of herbicidal secondary metabolites include, but are not limited to (i) amino acids (such as L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid)); (ii) peptides (such as Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin); (iii) nucleosides and analogs (Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S); (iv) Acyclic and cyclic esters (such as Phthoramycin, Kaimonolides, Bafilomycins, Borrelidin, Yokonolides, Vulgamycin, Pironetin, Diethyl 7-hydroxytriedeca-2,5,8,11-tetraenedioate); (v) organic acids (such as 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene); (vi) amides (such as Streptimidones, Cycloheximide, Naramycin B, Methoxhygromycin, N-Phenylpropanamide, N-(naphthalene-1-yl)propenamide, Thienodolin); (vii) oxazole-containing metabolites (such as Isoxazol-4-carboxylic acid, Phthoxazolins, Inthomycins, Oxazolomyin, Yanglingmycin); (viii) Antraquinones and Ansamycins (such as Hydranthomycin, Herbimycins, Geldanamycin, Abenquines); (ix) non-classified herbicidal compounds (such as Flavonoids, Gliricidin, Chrysin and Tectichrysin, Anisomycin (Methoxyphenone), Streptol, Caerulomycin).

### Biologically Active Compounds

The present disclosure provides biologically active compounds for controlling one or more plant species, as well as a new anucleated cell-based platform and/or an agricultural formulation for the encapsulation and delivery of biologically active compounds to target plants. In some embodiments, the anucleated cell-based platform and/or an agricultural formulation comprises an intact anucleated cell, which comprises at least one biologically active compounds. By way of non-limiting example, the biologically active compound is a nucleic acid, a polypeptide, a metabolite, or a semiochemical. There is currently great interest in the agricultural industry to begin replacing some of these synthetic compounds with their biologically derived counterparts. In some embodiments, the biologically active compound is a bioherbicide.

### Bioherbicides

In the context of agricultural applications of the present disclosure, the term “a biologically active agent” or “a bioactive agent” indicates that a composition, formulation, complex, or combination has a biological activity that impacts vegetative and reproductive growth of a plant in a negative sense in a selective manner. Thus, a bioactive agent may cause or promote a biological or biochemical activity within a target plant species to suppress, inhibit, limit, control the growth of or kill the target species. Thus, a bioactive agent of the present disclosure give rise to a biological control. Successful biological control reduces the population density of the target species. The term “a bioactive agent” that can be considered as a biocontrol agent refers to a composition, formulation, complex or combination which originates in a biological matter and is effective in the treatment, prevention, amelioration, inhibition, elimination or delaying the onset or growth of at least one of plant species. It is appreciated that an bioactive agent is environmentally safe, that it, it is detrimental to the target species, but does not substantially damage other species in a non-specific manner. In some embodiments, that the term “a bioactive agent” encompasses a bioherbicide as a natural herbicide.

The term “natural herbicide” or “bioherbicide” is referred to a natural product, metabolite, or fraction, originally derived from a microbial organism, typically a plant pathogen, that reduces the growth rate, development, or both the growth rate and development (for example, without limitation, as evidenced by reduced dry weight), possibly leading to death, of at least one target plant species. In one example, a natural herbicide of the present disclosure may exhibit selective activity when applied to one or more target plants, so that a plant of interest is less susceptible to the effects of the natural herbicide compared to one or more target plants. In another example, selective activity is such that a plant of interest is not substantially affected by the natural herbicide, while one or more target plants, for example a weed species is susceptible to the effects of the natural herbicide. Non limiting examples of a natural herbicide of the present disclosure include at least one microbes and metabolites derived/produced from microbial species. In the some embodiments, bioherbicides refer to a biologically active compounds a polypeptide, a metabolite, a semiochemical, a hormone, a pheromone, a macronutrient, a micronutrient, amino acids, peptides, nucleosides, nucleotides, macrolides, lactones, amide, amines, and the like.

The present disclosure teaches that bioherbicides of the present disclosure comprise a botanical blend of plant extracts and/or oils with herbicidal activity, a metabolite listed in Table 1, and a plurality of microbial species such as a Streptomyces species, an Actinomyces species, a Bacillus species and a Pseudomonas species.

The present disclosure provides that microbes including, but not limited to a Streptomyces species, a Bacillus species and a Pseudomonas species, which produce metabolites that have herbicidal activity. Thus, the microbial species taught herein can be used as bioherbicides because of the potential bioherbicidal activity. The present disclosure also teaches that bioactive herbicidal compounds, which are secondary metabolites described in Table 1, produced by soil microorganisms can be used to creating a bioherbicide for biological weed control. Those metabolites produced from microbes are reported in Bo et al. (2019) PLoS ONE 14(9): e0222933 and Shi et al., (2020) J. Agric. Food Chem. 68: 17-32, which are hereby incorporated by reference in its entirety.

TABLE 1
Herbicidal Secondary Metabolites from Streptomyces

| Family of Compounds | Identified Compounds | Bioactivity |
|---|---|---|
| Amino Acids | L-2-amino-4-(2-amino ethoxy)-trans-3- | Inhibits production of ethylene by plant tissues |
| | butenoic acid | (Pruess 1974) |
| | Alpha-methylene-beta-amino-propanoic | Growth inhibitor (Isaac 1991) |
| | acid | |
| | 4-Chlorothreonine | Growth inhibitor through amino acid metabolism |
| | | (Yoshida 1994) |
| | Homoalanosine | High herbicidal activity (cocklebur, ladysthumb) |
| | | (Fushimi 1989) |
| | Pyridazocidin | Significant pre-emergence herbicidal activities |
| | | against some dicotyl and monocotyl weeds |
| | | (Gerwick 1997) |
| | Acivicin | Inhibit the activity of glutamine synthetase |
| | | (patented as herbicide) (Burdge 1996) |
| | Gostatin | Inhibited aminotransferase and showed moderate |
| | | phytotoxicity (Nishino 1983, 1984) |
| | Gabaculine | Inhibited photosynthesis through the inhibition of |
| | | the synthesis of porphyrin and chlorophyll (Rando |
| | | 1977, Kahn 1987, Kedy 1994) |
| | L-1,4-cyclohexadiene-1-alanine | Herbicidal activity at root level (Gao 2008) |
| | cis-L-2-amino-1-hydroxycyclobutane-1- | Causes significant chlorosis, severe bleaching and |
| | acetic acid | reduction of growth (Ayer 1991) |
| | Oxetin (2R,3S)-3-aminooxetane-2- | Herbicidal activity in alfalfa and turnip (Omura |
| | carboxylic acid) | 1984) |
| Peptides and Amides | Bialaphos | Decomposition by hydrolysis into Glufosinate in |
| | Phosalacine | weeds (Mase 1984, Satoh 1993, Omura 1984, Kato |
| | Trialaphos | 1991) |
| | Phosphonothricin (hydrolyzed compound of | Inhibition of glutamate synthetase (Glufosinate) |
| | Bialaphos) | (Bayer 1972, Hoerlein 1994) |
| | Plumbemycins | Herbicidal activity (Natchev 1988) |
| | γ-Glutamyl-methionine sulfoximine (γ-Glu | Hydrolyzed compound MSO high herbicidal |
| | MSO) | activity in vitro (Murakoshi 1993) |
| | L-(N5-Phosphono)methionine-S- | Hydrolyzed compounds phosphono-MSO and MSO |
| | sulfoximinyl-L-alanyl-L-alanine | showed strong inhibition against glutamine |
| | | synthetase. |
| | Resormycin | Strong herbicidal activity against many weeds, |
| | | especially dicotyledonous weeds by foliar |
| | | application, while no activity |
| | | by soil application (Igarashi 1997, 2001) |
| | Rotihibins | Inhibitor of plant growth (Fukuchi 1995) |
| | Actinonin | Inhibited plastid peptide deformylase, which causes |
| | | chlorosis in plants (Hou 2006) |
| | 2,5-diketopiperazine thaxtomins | Good growth inhibition (King 1996, 2001) |
| | Thaxtomin A | Good pre-emergence herbicidal activity. Patented |
| | | as a herbicide which inhibits cellulose synthesis |
| | | through affecting the formation of cellulose |
| | | synthase complexes on the outside of the plasma |
| | | membrane (Koivunen 2010, Bischoff 2009) |
| | Eponemycin and Eporpomycins | Inhibited cell wall synthesis (Tsuchiya 1997) |
| Nucleosides and analogues | Nebularine | Inhibited plant growth by producing anormal |
| | | chromosomes in the cells of root via antagonistic |
| | | effect on cytokinins through non-competitive |
| | | inhibition of xanthine oxidase (Brown 1994) |
| | Coaristeromycin | High herbicidal activity against yellow nutsedge, |
| | | johnsongrass, barnyard grass and Indian mustard |
| | | (Isaac 1991) |
| | Ara-A | Herbicidal activity against E. crus-galli, Digitaria |
| | | adscendens, |
| | | Chenopodium ficifolium, etc. in a pot assay (Awaya |
| | | 1979) |
| | Albucidin | High levels of broad-spectrum post-emergence |
| | | herbicidal activity as well as moderate pre- |
| | | emergence activity, also |
| | | induced chlorosis and bleaching in many tested |
| | | grass and broadleaf weeds (Hahn et al 2009) |
| | Coformycin | Herbicidal activity against seedlings of johsongrass |
| | | (Sorghum halepense), barnyard grass (E. crus- |
| | | galli), morning glory (Pharbitis nil), crabgrass |
| | | (Digitaria sanguinalis), and Indian mustard |
| | | (Brassica juncea L.) (Isaac 1991) |
| | 5′-Deoxytoyocamycin | Caused plant bleaching (Brown 1994) |
| | Toyocamycin | Inhibition of the auxin signaling mediated by the |
| | | SCFTIR1 pathway (Hayashi et al 2009) |
| | Tubercidin | Inhibited the growth of radish shoot and root (Kim |
| | | 1996) |
| | 5′-O-Sulfamoyltubercidin | Exhibited control effects against Digitaria sp. |
| | | similar to bialaphos and better effects against |
| | | Polygonum lapathifolium than bialaphos (Iwata |
| | | 1987) |
| | Sangivamycin | Good weed killing properties in a greenhouse assay |
| | | (Hwang 2005) |
| | Dealanylascamycin | Showed potent post-emergence herbicidal activity |
| | | (patented as herbicide) (Pachlatko 1993, Isono |
| | | 1984, Scacchi 1994) |
| | Herbicidins | Strong inhibition on seed germination of cabbage |
| | | and rice, showing selective herbicidal activity |
| | | against dicotyledonous weeds by foliar application |
| | | (Arai 1976, Terahara 1982, Haneishi 1976) |
| | Hydantocidin | Broad spectrum of non-selective herbicidal activity |
| | | against monocotyledous and dicotyledous weeds, |
| | | which was comparable to glyphosate and better |
| | | than bialaphos (Fonne-Pfister 1996) |
| | Blasticidin S and 5-hydroxylmethyl- | Broad spectrum of herbicidal activity through the |
| | blasticidin S | inhibition of protein synthesis (Scacchi 1992) |
| Acyclic and Cyclic Esters | Phthoramycin | Showed inhibition of biosynthesis of cellulose |
| | | (Tanaka 1995) |
| | Kaimonolides | Showed inhibition of root elongation (Hirota 1990) |
| | Bafilomycins | Herbicidal activity (Kim 1993, Natsume 2005) |
| | Borrelidin | Caused necrosis and inhibited plant growth (Cao |
| | | 2012) |
| | Yokonolides | Inhibited the auxin signaling, which might affect |
| | | the growth of plants (Hayashi 2001, Kirst 1993) |
| | Vulgamycin | High herbicidal activity against dicotyledonous |
| | | weeds, might affect the isoleucine-dependent |
| | | pathway and influence an isoleucine-dependent |
| | | step within the cell cycle (Babczinski 1991) |
| | Pironetin | Showed plant-growth regulating activity |
| | | (Kobayashi 1994) |
| | Diethyl 7-hydroxytriedeca-2,5,8,11- | Showed better herbicidal activity than 2,4-D at the |
| | tetraenedioate | same concentration against E. crus-galli L., |
| | | Amaranthus spinosus L., and Cyperus rotundus in |
| | | vitro (Priyadharsini 2017) |
| Organic Acids | 1-Hydroxy-4-methoxy-naphthoic acid | Plant growth inhibition (Pfefferle 1997) |
| | Pyrrol-2-carboxylic acid | Inhibited the root growth of radish (Wei 2017) |
| | Fosmidomycin | Effective inhibition against the deoxylulose |
| | | reductoisomerase in the chloroplasts of plants |
| | | (patented as herbicide) (Zeidler 1998, Kuzuyama |
| | | 1998, Kamuro 1991) |
| | Pteridic acids | Inhibited the germination of rice seeds and induced |
| | | the formation of adventitious roots in the hypocotyl |
| | | of kidney beans, which is comparable to indole |
| | | acetic acid (Igarashi 2002) |
| | Maduramycin | Inhibited germination and radicle elongation of |
| | | some weeds and caused phytotoxic injury and |
| | | biomass reduction via foliar application (Gutierrez- |
| | | Lugo 1999) |
| | Nigericin | Showed growth inhibition against the radicle of |
| | | garden cress (Heisey 1986) |
| | Monensin | Caused herbicidal symptoms (Hoagland 1996) |
| | Laidlomycin | Inhibited de novo starch synthesis by inhibiting |
| | | photophosphorylation (Kida 1986) |
| | Herboxidiene | Strong herbicidal activity against several weeds as |
| | | the conventional herbicide tested (Isaac 1992) |
| Amides (not peptides) | Streptimidones | Inhibited the growth of L. minor and oat (Chatterjee |
| | | 1995) |
| | Cycloheximide and Naramycin B | Showed good post-emergence herbicidal activity |
| | | without selectivity, and could be used as a highly |
| | | active citrus abscission agent (Berg 1982) |
| | Methoxhygromycin | Showed stronger herbicidal activity against |
| | | monocotyledous grasses than dicotyledon weeds |
| | | and caused bleaching on some weeds (Lee 2003) |
| | N-Phenylpropanamide and | Showed inhibition on the germination of seeds of |
| | N-(naphthalene-1-yl)propanamide | Cyperus occidentalis and the rhizome of Cyperus |
| | | rotundus (Priyadharsini 2013) |
| | Thienodolin | Inhibited the growth of rice seedlings (Kanbe 1993) |
| Oxazole-containing | Isoxazol-4-carboxylic acid | Showed phytotoxicity against rice seedlings |
| Metabolites | | (Kobinata 1991) |
| | Phthoxazolins | inhibited the growth of radish seedlings and |
| | | sorghum (Omura 1990, Tanaka 1993) |
| | Inthomycins | inhibited the germination and growth of weed seeds |
| | | (Henkel 1991, Zhou 2009) |
| | Oxazolomyin | Caused necrosis on potato and inhibited the |
| | | germination of alfalfa seeds (Kawazu 1992) |
| | Yanglingmycin | Showed inhibition of seed germination and root |
| | | elongation (Wang 2015) |
| Antraquinones and | Hydranthomycin | Showed some herbicidal activity on sorghum and |
| Ansamycins | | radish (Tanaka 1995) |
| | Herbimycins | Showed potent herbicidal activity against the tested |
| | | weeds (Omura 1979, Iwai 1980) |
| | Geldanamycin | Herbicidal activity (Heisey 1986) |
| | Abenquines | Progressively inhibited the growth of a blue-green |
| | | algae (Nain-Perez 2017) |
| Not Classified Herbicidal | Flavonoids | Broad spectrum of herbicidal activity (Tao 2006) |
| Compounds | Gliricidin | Inhibited the root growth of radish (Wei 2017) |
| | Chrysin and Tectichrysin | Showed inhibitory effects on root growth (Chen |
| | | 2010) |
| | Anisomycin (Methoxyphenone) | Inhibited the growth of annual gramineous weeds |
| | | and broadleaf weeds. Commercialized as |
| | | Methoxyphenone for the |
| | | control of annual weeds in rice, soybean, cotton, |
| | | sugarcane, through pre-emergence treatment |
| | | (Yamada 1972, Ito 1974) |
| | Streptol | Herbicidal activity against lettuce (Isogai 1987) |
| | Caerulomycin | Caused wilting of cuttings of tomato plants through |
| | | metal chelation (Divekar 1967) |

In some embodiments, biologically active compounds or bioactive agents are herbicides. The bioactive agents are a botanical blend, a metabolite, at least one microbial species, and combinations thereof.

In some embodiments, said botanical blend is a plant extract or oil having a herbicidal activity.

In some embodiment, said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound. In other embodiment, said metabolite are listed in Table 1. Non-limiting examples of the metabolite as the bioactive agent is L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (7-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof.

In another embodiment, said microbial species is selected from a Streptomyces genus, an Actinomyces genus, a Bacillus genus and a Pseudomonas genus. In another embodiment, said microbial species is Streptomyces rimosus or Bacillus megaterium.

### Minicells

Minicells are the result of aberrant, asymmetric cell division, and contain membranes, peptidoglycan, ribosomes, RNA, protein, and often plasmids but no chromosome. (Frazer A C and Curtiss III, Production, Properties and Utility of Bacterial Minicells, Curr. Top. Microbial. Immunol. 69:1-84 (1975)). Because minicells lack chromosomal DNA, minicells cannot divide or grow, but they can continue other cellular processes, such as ATP synthesis, replication and transcription of plasmid DNA, and translation of mRNA. Although chromosomes do not segregate into minicells, extrachromosomal and/or episomal genetic expression elements may segregate, or may be introduced into minicells after segregation from parent cells.

In embodiments, the minicells described herein are non-naturally occurring.

In some embodiments, the disclosure provides a composition comprising a plurality of minicells. In some embodiments, the disclosure provides a composition comprising a plurality of minicells comprising at least one biologically active compound within said cell. In some embodiments, the disclosure provides a composition comprising a plurality of minicells, wherein each minicell of said plurality comprises an enzymatically active polypeptide displayed on the surface of the minicell, wherein said enzymatically active polypeptide has enzymatic activity. The enzymatic activity is derived from enzymatically active polypeptides disclosed in the present disclosure.

In some embodiments, the invention provides a composition comprising a plurality of intact, bacterially-derived minicells. In some embodiments, the disclosure provides a composition comprising a plurality of intact, bacterially-derived minicells comprising at least one biologically active compound within said cell. In some embodiments, the invention provides a composition comprising a plurality of intact, bacterially-derived minicells, wherein each minicell of said plurality comprises an enzymatically active polypeptide displayed on the surface of the bacterial minicell, wherein said enzymatically active polypeptide has enzymatic activity. In some embodiments, the composition comprises minicells which further comprise a second polypeptide displayed on the surface of the bacterial minicell, to increase adhesion to a subject and/or subjects including, but are not limited to substrates of enzymes, receptors, metal, plastic, soil, bacteria, fungi, pathogens, germs, plants, animals, human, and the like. In some embodiments, the composition comprises a mixture of minicells, wherein certain minicells within the mixed minicell population display the enzymatically active polypeptide or display the second polypeptide including subject adhesion increasing polypeptide or display both.

### Eubacterial Minicells

One type of minicell is a eubacterial minicell. For reviews of eubacterial cell cycle and division processes, see Rothfield et al., Annu. Rev. Genet., 33:423-48, 1999; Jacobs et al., Proc. Nat. Acad. Sci. USA, 96:5891-5893, May, 1999; Koch, Appl. and Envir. Microb., Vol. 66, No. 9, pp. 3657-3663; Bouche and Pichoff, Mol Microbiol, 1998. 29: 19-26; Khachatourians et al., J Bacteriol, 1973. 116: 226-229; Cooper, Res Microbiol, 1990. 141: 17-29; and Danachie and Robinson, “Cell Division: Parameter Values and the Process,” in: Escherichia Coli and Salmonella Typhimurium: Cellular and Molecular Biology, Neidhardt, Frederick C., Editor in Chief, American Society for Microbiology, Washington, D.C., 1987, Volume 2, pages 1578-1592, and references cited therein; and Lutkenhaus et al., “Cell Division,” Chapter 101 in: Escherichia coli and Salmonella typhimurium: Cellular and Molecular Biology, 2^{nd} Ed., Neidhardt, Frederick C., Editor in Chief, American Society for Microbiology, Washington, D.C., 1996, Volume 2, pages 1615-1626, and references cited therein. When DNA replication and/or chromosomal partitioning is altered, membrane-bounded vesicles “pinch off” from parent cells before transfer of chromosomal DNA is completed. As a result of this type of dysfunctional division, minicells are produced which contain an intact outer membrane, inner membrane, cell wall, and all of the cytoplasm components but do not contain chromosomal DNA.

In some embodiments, the bacterially-derived minicells are produced from a strain, including, but are not limited to a strain of Escherichia coli, Bacillus spp., Salmonella spp., Listeria spp., Mycobacterium spp., Shigella spp., or Yersinia spp. In some embodiments, the bacterially-derived minicells are produced from a strain that naturally produces minicells. Such natural minicell producing strains produce minicells, for example, at a 2:1 ratio (2 bacterial cells for every one minicell). In certain embodiments, exemplary bacterial strains that naturally produce minicells include, but are not limited to E. coli strain number P678-54, Coli Genetic Stock Center (CGSC) number: 4928 and B. subtilis strain CU403.

As one example, mutations in B. subtilis smc genes result in the production of minicells (Britton et al., 1998, Genes and Dev. 12:1254-1259; Moriya et al., 1998, Mol Microbiol 29:179-87). Disruption of smc genes in various cells is predicted to result in minicell production therefrom.

As another example, mutations in the divIVA gene of Bacillus subtilis results in minicell production. When expressed in E. coli, B. subtilis or yeast Schizosaccharomyces pombe, a DivIVA-GFP protein is targeted to cell division sites therein, even though clear homologs of DivIVA do not seem to exist in E. coli, B. subtilis or S. pombe (David et al., 2000, EMBO J. 19:2719-2727. Over- or under-expression of B. subtilis DivIVA or a homolog thereof may be used to reduce minicell production in a variety of cells.

In some embodiments, the minicell-producing bacteria is a Gram-negative bacteria. The Gram-negative bacteria includes, but is not limited to, Escherichia coli, Salmonella spp. including Salmonella typhimurium, Shigella spp. including Shigella flexneri, Pseudomonas aeruginosa, Agrobacterium, Campylobacter jejuni, Lactobacillus spp., Neisseria gonorrhoeae, and Legionella pneumophila. In some embodiments, the minicell-producing gram-negative bacteria can produce minicells naturally caused by endogenous or exogenous mutation(s) associated with cell division and/or chromosomal partitioning. In some embodiments, the minicell-producing bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing gram-negative bacteria is deficient in protease and/or its activity naturally and/or by genetic engineering techniques disclosed herein. In some embodiments, the protease-deficient minicell-producing gram-negative bacteria comprises a recombinant expression vector comprising a gene or genes that is involved in a protein of interest disclosed in the present disclosure.

In some embodiments, the minicell-producing bacteria can be a Gram-positive bacteria. The Gram-positive bacteria includes, but is not limited to, Bacillus subtilis, Bacillus cereus, Corynebacterium Glutamicum, Lactobacillus acidophilus, Staphylococcus spp., or Streptococcus spp. In some embodiments, the minicell-producing gram-positive bacteria can produce minicells naturally caused by endogenous or exogenous mutation(s) associated with cell division and/or chromosomal partitioning. In some embodiments, the minicell-producing gram-positive bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing gram-positive bacteria is deficient in protease and/or its activity naturally and/or by genetic engineering techniques disclosed herein. In some embodiments, the protease-deficient minicell-producing gram-positive bacteria comprises a recombinant expression vector comprising a gene or genes that is involved in a protein of interest disclosed in the present disclosure.

The minicell-producing bacteria can be a Extremophilic bacteria. The Extremophilic bacteria includes, but is not limited to, Thermophiles including Thermus aquaticus, Psychrophiles, Piezophiles, Halophilic bacteria, Acidophile, Alkaliphile, Anaerobe, Lithoautotroph, Oligotroph, Metallotolerant, Oligotroph, Xerophil or Polyextremophile. In some embodiments, the minicell-producing Extremophilic bacteria can produce minicells naturally caused by endogenous or exogenous mutation(s) associated with cell division and/or chromosomal partitioning. In some embodiments, the minicell-producing Extremophilic bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing Extremophilic bacteria is deficient in protease and/or its activity naturally and/or by genetic engineering techniques disclosed herein. In some embodiments, the protease-deficient minicell-producing Extremophilic bacteria comprises a recombinant expression vector comprising a gene or genes that is involved in a protein of interest disclosed in the present disclosure.

### Eukaryotic Minicells

Achromosomal eukaryotic minicells (i.e., anucleate cells) are within the scope of the disclosure. Yeast cells are used to generate fungal minicells. See, e.g., Lee et al., Ibd1p, a possible spindle pole body associated protein, regulates nuclear division and bud separation in Saccharomyces cerevisiae, Biochim Biophys Acta 3:239-253, 1999; Kopecka et al., A method of isolating anucleate yeast protoplasts unable to synthesize the glucan fibrillar component of the wall J Gen Microbiol 81:111-120, 1974; and Yoo et al., Fission yeast Hrp1, a chromodomain ATPase, is required for proper chromosome segregation and its overexpression interferes with chromatin condensation, Nucl Acids Res 28:2004-2011, 2000. Cell division in yeast is reviewed by Gould and Simanis, The control of septum formation in fission yeast, Genes & Dev 11:2939-51, 1997).

In some embodiments, the eukaryotic minicells can be produced from yeast cells, such as Saccharomyces cerevisiae, Pichia pastoris and/or Schizosaccharomyces pombe.

As one example, mutations in the yeast genes encoding TRF topoisomerases result in the production of minicells, and a human homolog of yeast TRF genes has been stated to exist (Castano et al., 1996, Nucleic Acids Res 24:2404-10). Mutations in a yeast chromodomain ATPase, Hrp1, result in abnormal chromosomal segregation; (Yoo et al., 2000 Nuc. Acids Res. 28:2004-2011). Disruption of TRF and/or Hrp1 function is predicted to cause minicell production in various cells. Genes involved in septum formation in fission yeast (see, e.g., Gould et al., 1997 Genes and Dev. 11:2939-2951) can be used in like fashion.

Platelets are a non-limiting example of eukaryotic minicells. Platelets are anucleate cells with little or no capacity for de novo protein synthesis. The tight regulation of protein synthesis in platelets (Smith et al., 1999, Vasc Med 4:165-72) may allow for the over-production of exogenous proteins and, at the same time, under-production of endogenous proteins. Thrombin-activated expression elements such as those that are associated with Bcl-3 (Weyrich et al., Signal-dependent translation of a regulatory protein, Bcl-3, in activated human platelets, Cell Biology 95:5556-5561, 1998) may be used to modulate the expression of exogenous genes in platelets.

As another non-limiting example, eukaryotic minicells are generated from tumor cell lines (Gyongyossy-Issa and Khachatourians, Tumour minicells: single, large vesicles released from cultured mastocytoma cells (1985) Tissue Cell 17:801-809; Melton, Cell fusion-induced mouse neuroblastomas HPRT revertants with variant enzyme and elevated HPRT protein levels (1981) Somatic Cell Genet. 7: 331-344).

Yeast cells are used to generate fungal minicells. See, e.g., Lee et al., Ibd1p, a possible spindle pole body associated protein, regulates nuclear division and bud separation in Saccharomyces cerevisiae, Biochim Biophys Acta 3:239-253, 1999; Kopecka et al., A method of isolating anucleate yeast protoplasts unable to synthesize the glucan fibrillar component of the wall J Gen Microbiol 81:111-120, 1974; and Yoo et al., Fission yeast Hrp1, a chromodomain ATPase, is required for proper chromosome segregation and its overexpression interferes with chromatin condensation, Nucl Acids Res 28:2004-2011, 2000. Cell division in yeast is reviewed by Gould and Simanis, The control of septum formation in fission yeast, Genes & Dev 11:2939-51, 1997). In some embodiments, the present disclosure teaches production of yeast minicells.

### Archaebacterial Minicells

The term “archaebacterium” is defined as is used in the art and includes extreme thermophiles and other Archaea (Woese, C. R., L. Magrum. G. Fox. 1978. Archaebacteria. Journal of Molecular Evolution. 11:245-252). Three types of Archaebacteria are halophiles, thermophiles and methanogens. By physiological definition, the Archaea (informally, archaes) are single-cell extreme thermophiles (including thermoacidophiles), sulfate reducers, methanogens, and extreme halophiles. The thermophilic members of the Archaea include the most thermophilic organisms cultivated in the laboratory. The aerobic thermophiles are also acidophilic; they oxidize sulfur in their environment to sulfuric acid. The extreme halophiles are aerobic or microaerophilic and include the most salt tolerant organisms known. The sulfate-reducing Archaea reduce sulfate to sulfide in extreme environment. Methanogens are strict anaerobes, yet they gave rise to at least two separate aerobic groups: the halophiles and a thermoacidophilic lineage. Non-limiting examples of halophiles include Halobacterium cutirubrum and Halogerax mediterranei. Non-limiting examples of methanogens include Methanococcus voltae; Methanococcus vanniela; Methanobacterium thermoautotrophicum; Methanococcus voltae; Methanothermus fervidus; and Methanosarcina barkeri. Non-limiting examples of thermophiles include Azotobacter vinelandii; Thermoplasma acidophilum; Pyrococcus horikoshii; Pyrococcus furiosus; and Crenarchaeota (extremely thermophilic archaebacteria) species such as Sulfolobus solfataricus and Sulfolobus acidocaldarius.

Archaebacterial minicells are within the scope of the invention. Archaebacteria have homologs of eubacterial minicell genes and proteins, such as the MinD polypeptide from Pyrococcus furiosus (Hayashi et al., EMBO J. 20:1819-28, 2001). It is thus possible to create Archaebacterial minicells by methods such as, by way of non-limiting example, overexpressing the product of a min gene isolated from a prokaryote or an archaebacterium; or by disrupting expression of a min gene in an archaebacterium of interest by, e.g., the introduction of mutations thereof or antisense molecules thereto. See, e.g., Laurence et al., Genetics 152:1315-1323, 1999.

By physiological definition, the Archaea (informally, archaes) are single-cell extreme thermophiles (including thermoacidophiles), sulfate reducers, methanogens, and extreme halophiles. The thermophilic members of the Archaea include the most thermophilic organisms cultivated in the laboratory. The aerobic thermophiles are also acidophilic; they oxidize sulfur in their environment to sulfuric acid. The extreme halophiles are aerobic or microaerophilic and include the most salt tolerant organisms known. The sulfate-reducing Archaea reduce sulfate to sulfide in extreme environment. Methanogens are strict anaerobes, yet they gave rise to at least two separate aerobic groups: the halophiles and a thermoacidophilic lineage. In some embodiments, the present disclosure teaches production of archaeal minicells.

Minicells Derived from Endophytes

An endophyte is an endosymbiont, often a bacterium or fungus, that lives within a plant for at least part of its life cycle. The endophyte can transport itself from the environment to internal organs of plants. Non-limiting examples of endophytes include Acidovorax facilis, Bradyrhizobium, Rhizobium, Rhodococcus rhodochrous, Colletotrichum, Curvularia, Epichloë, Fusarium, Mycosphaerella, Neotyphodium, Piriformospora, and Serendipita. In some embodiments, the present disclosure teaches production of endophyte-derived minicells. In other embodiments, endophyte-derived minicells can enter into internal plant cell, tissues, or organs, and function as an invasive minicell.

Fungal endophytes have the ability to colonize inter- or intra-cellularly. The colonization process involves several steps, including host recognition, spore germination, penetration of the epidermis and tissue multiplication. Once the endophytes are successfully colonized in the host tissue, the endophytic niche becomes established. In the endophytic niche, endophytes will obtain a reliable source of nutrition from the plant fragment, exudates and leachates and protect the host against other microorganisms (Gao et al., 2010). In some embodiments, minicells produced from fungal endophytes can transmit the active compounds within and/or on their surface to a target using their invasive capability.

Minicells Derived from Plant Pathogen Bacteria

The present disclosure provides plant pathogen bacteria, which can be utilized for minicell production, including but are not limited to (1) Pseudomonas syringae pathovars; (2) Ralstonia solanacearum; (3) Agrobacterium tumefaciens; (4) Xanthomonas oryzae pv. oryzae; (5)Xanthomonas campestris pathovars; (6)Xanthomonas axonopodis pathovars; (7)Erwinia amylovora; (8) Xylella fastidiosa; (9) Dickeya (dadantii and solani); (10)Pectobacterium carotovorum (and Pectobacterium atrosepticum), (11) Clavibacter michiganensis (michiganensis and sepedonicus), (12) Pseudomonas savastanoi, and (13) Candidatus Liberibacter asiaticus. Such plant pathogen bacteria natively have the capacity to penetrate and invade into internal host tissues in their natural state. In some embodiments, minicells derived from plant pathogen bacteria described above can naturally deliver biologically active compounds disclosed herein into internal cells, tissues, and/or organs of a target host in their natural ability of invasion, penetration, and/or transmission into internal parts of a target.

From example, some pathogen bacteria are found to secrete cell wall-degrading endoglucanase and endopolygalacturonase, potentially explaining penetration into the root endosphere. Other pathogen bacteria can penetrate through the stomata into the substomatal chamber, and colonization of the intercellular spaces of the leaf mesophyll. The minicells produced from these pathogen bacteria possess and utilize natural ability of invading, penetrating and/or transmitting for scalable and targeted delivery of active compounds disclosed herein.

### Bacterial Minicell Production

Minicells are produced by parent cells having a mutation in, and/or overexpressing, or under expressing a gene involved in cell division and/or chromosomal partitioning, or from parent cells that have been exposed to certain conditions, that result in aberrant fission of bacterial cells and/or partitioning in abnormal chromosomal segregation during cellular fission (division). The term “parent cells” or “parental cells” refers to the cells from which minicells are produced. Minicells, most of which lack chromosomal DNA (Mulder et al., Mol Gen Genet, 221: 87-93, 1990), are generally, but need not be, smaller than their parent cells.

Minicells are achromosomal, membrane-encapsulated biological nanoparticles (400 nm) that are formed by bacteria following a disruption in the normal division apparatus of bacterial cells. Minicells can also be 400 nm to 650 nm in size. In essence, minicells are small, metabolically active replicas of normal bacterial cells with the exception that they contain no chromosomal DNA and as such, are non-dividing and non-viable. Although minicells do not contain chromosomal DNA, the ability of plasmids, RNA, native and/or recombinantly expressed proteins, and other metabolites have all been shown to segregate into minicells. Some methods of construction of minicell-producing bacterial strains are discussed in detail in U.S. patent application Ser. No. 10/154,951(US Publication No. US/2003/0194798 A1), which is hereby incorporated by reference in its entirety.

Disruptions in the coordination between chromosome replication and cell division lead to minicell formation from the polar region of most rod-shaped prokaryotes. Disruption of the coordination between chromosome replication and cell division can be facilitated through the overexpression of some of the genes involved in septum formation and binary fission. Alternatively, minicells can be produced in strains that harbor mutations in genes that modulate septum formation and binary fission. Impaired chromosome segregation mechanisms can also lead to minicell formation as has been shown in many different prokaryotes.

### Plasmid Based Methods of Minicell Production

In some embodiments, minicell production can be achieved by the overexpression or mutation of genes involved in the segregation of nascent chromosomes into daughter cells. For example, mutations in the parC or mukB loci of E. coli have been demonstrated to produce minicells. The overexpression or mutation of a cell division gene capable of driving minicell production in one family member, can be used to produce minicells in another. For example, it has been shown that the overexpression E. coli ftsZ gene in other Enterobacteriacea family members such as Salmonella spp. and Shigella spp as well as other class members such as Pseudomonas spp. will result in similar levels of minicell production.

In some embodiments, minicells can be produced in E. coli by the overproduction of the protein FtsZ which is an essential component of the Min division system by which E. coli operates. Overproduction of this protein in E. coli results in the inability for this ring to be spatially restricted to the midsection of the cell, thus resulting in production of minicells upon cell division. Because the overproduction of FtsZ can create minicells, it can be overexpressed using a plasmid based system.

The same can be demonstrated in the mutation-based minicell producing bacterial strains. For example, deletion of the Min locus in any of bacterial strains results in minicell production. Cell division genes in which mutation can lead to minicell formation include but are not limited to the min genes (such as minC, minD, and minE).

In some embodiments, E. coli rely on the min system in order to ensure proper replication of parent cells into daughter cells. This min system (known as the minB operon) consists of 3 parts, minD, minC, and minE. These genes work together in order to control the placement of the Z-ring which is comprised of polymerized FtsZ protein. MinC consists of two distinct domains, both of which interact directly with the FtsZ protein in order to inhibit polymerization (Z-ring formation). MinD is a protein that is associated with the membrane that forms at one of the cell's poles and polymerizes toward the cell's mid-point. It binds MinC which is distributed throughout the cytoplasm. MinE is a protein that binds to MinD as well and releases MinC. It polymerizes into a ring like shape and oscillates from pole to pole in the cell.

In some embodiments, this system can be manipulated in order to shift the Z-ring to a polar end of the cell which excludes the nucleoid DNA upon completion of replication. The Z-ring can be shifted by not allowing the cell to sequester MinC to the polar ends of the cell. In the absence of MinC or MinD, or overexpression of MinE, E. coli cells will form achromosomal and/or anucleate cells. The FtsZ and the Min systems for causing asymmetrical cell division are exemplified by Piet et al, 1990, Proc. Natl. Acad. Sci. USA 87:1129-1133 and Xuan-Chuan et al, 2000, J Bacteriol. 182(21):6203-62138, each of which is incorporated herein by reference.

Genes can be introduced in a site directed fashion using homologous recombination. Homologous recombination permits site specific modifications in endogenous genes and thus inherited or acquired mutations may be corrected, and/or novel alterations may be engineered into the genome. Homologous recombination and site-directed integration in plants are discussed in, for example, U.S. Pat. Nos. 5,451,513; 5,501,967 and 5,527,695.

In some embodiments, minicells are produced by deleting, mutating, knocking out, or disrupting minC, minD, and/or minC and minD gene(s) in bacteria by traditional gene engineering techniques including homologous recombination. In other embodiments, minicells are produced by overexpressing certain genes such as ftsZ and/or minE in bacteria.

### Controlled Production of Minicells

In some embodiments, the present disclosure teaches mutating cell populations by introducing, deleting, or replacing selected portions of genomic DNA. Thus, in some embodiments, the present disclosure teaches methods for targeting mutations to a specific locus such as ftsZ, minC, minD, minC/D, and minE. In other embodiments, the present disclosure teaches the use of gene editing technologies such as ZFNs, TALENS, CRISPR or homing endonucleases, to selectively edit target DNA regions. In aspects, the targeted DNA regions is ftsZ, minC, minD, minC/D, and minE.

Engineered nucleases such as zinc finger nucleases (ZFNs), Transcription Activator Like Effector Nucleases (TALENs), engineered homing endonucleases, and RNA or DNA guided endonucleases, such as CRISPR/Cas such as Cas9 or CPF1, are particularly appropriate to carry out some of the methods of the present disclosure. Additionally or alternatively, RNA targeting systems can use used, such as CRISPR/Cas systems have RNA targeting nucleases.

In some embodiments, one skilled in the art can appreciate that the Cas9 disclosed herein can be any variant described in the literature, including but not limited to the functional mutations described in: Fonfara et al. Nucleic Acids Res. 2014 February; 42(4):2577-90; Nishimasu H. et al. Cell. 2014 Feb. 27; 156(5):935-49; Jinek M. et al. Science. 2012 337:816-21; and Jinek M. et al. Science. 2014 Mar. 14; 343(6176); see also U.S. patent application Ser. No. 13/842,859 filed Mar. 15, 2013, which is hereby incorporated by reference; further, see U.S. Pat. Nos. 8,697,359; 8,771,945; 8,795,965; 8,865,406; 8,871,445; 8,889,356; 8,895,308; 8,906,616; 8,932,814; 8,945,839; 8,993,233; and 8,999,641, which are all hereby incorporated by reference. Thus, in some embodiments, the systems and methods disclosed herein can be used with the wild type Cas9 protein having double-stranded nuclease activity, Cas9 mutants that act as single stranded nickases, deactivated Cas9 (dCas9) that has no nuclease activity, or other mutants with modified nuclease activity.

In some examples, a Type II nuclease may be catalytically dead (e.g. dCas9, “dead Cas9,” “deactivated Cas9”) such that it binds to a target sequence, but does not cleave. dCAS9 is a variant of the CAS9 protein (CRISPR) that has had its active site altered to no longer be able to edit genomes, but can still bind to highly specific segments of the genome using a guide RNA. This protein can stop transcription of the gene if bound. In some embodiments, the dCAS9 gene can be placed under inducible control so that its expression would be controlled. The guide RNA corresponding to the knockout within the Min system could be included on a plasmid or cut into the genome and placed under inducible control. Upon induction with this system, the guide RNA would direct the dCAS9 protein to the gene within the Min system in order to stop its expression. The stopping of expression of this gene such as minC, minD, and minC/D would result in the formation of minicells.

### Antibiotic Resistance Knock In-Knock Out

In some embodiments, the present disclosure teaches uses of the genetic manipulation technique using Lambda-Red recombination system in order to edit genome integrated with exogenous expression cassette such as an selectable marker such as antibiotic resistant gene. In some embodiments, an selectable marker such as antibiotic resistant gene is integrated into the host genome (e.g. bacteria) in order to knockout minC/D/CD gene for inducing minicell production. If the marker with antibiotic resistance is no longer desired after successfully selecting the minicells in which the target gene (such as minC/D/CD) is knocked out, the flippase can be used to remove the integrated antibiotic resistant gene cassette from the host genome. A fragment of linear DNA is inserted into the genome directed by that fragment homology to the genome. This can be used to knock in genes of interest or to knockout genes of interest by replacing them with an antibiotic resistance cassette such as Chloramphenicol-resistant gene, kanamycin-resistant gene, spectinomycin-resistant gene, streptomycin-resistant gene, ampicillin-resistant gene, tetracycline-resistant gene, erythromycin-resistant gene, bleomycin-resistant gene, and bleomycin-resistant gene. A successful genetic manipulation is then selected for using this antibiotic resistance cassette. If a flippase recombination target (FRT) site is included within the resistance cassette for further genetic manipulations, it can be used for removing the antibiotic resistant gene integrated into the genome in vivo after selection of target minicells. The enzyme used for this is recombinase flippase and is often expressed from a plasmid that can be removed from the cell line using a temperature sensitive origin of replication. Recombinase flippase recognizes two identical FRT sites on both the 5′ and 3′ ends of the antibiotic resistance cassette and removes the DNA between the two sites. In some embodiments, the FRT site can be included within an antibiotic resistance cassette to remove the antibiotic resistance cassette after its use.

### Strains for Minicell Production

A E. coli P678-54 strain is obtained from Coli Genetic Stock Center (CGSC), and is used to produce minicells (Adler et al., 1967, Proc. Natl. Acad. Sci. USA 57:321-326; Inselburg J, 1970 J. Bacteriol. 102(3):642-647; Frazer 1975, Curr. Topics Microbiol. Immunol. 69:1-84).

In some embodiments, an anucleated cell is produced from a P678-54 E. coli parental strain. The anucleated cell produced from P678-54 parental bacterial strain is used as an anucleated cell-based platform and/or an agricultural formulation for the encapsulation and delivery of biologically active compounds.

### Protease-Deficient Bacterial Strains

The present disclosure provides the production of minicells from B strains using genetically-engineering techniques including B strains including BL21, BL21 (DE3), and BL21-AI are deficient in Lon protease (cytoplasm) and OmpT protease (outer membrane). Accordingly, B strains as protease-deficient strains can be utilized to create protease-deficient and/or protease-deficient minicells. The DE3 designation means that respective strains contain the λDE3 lysogen that carries the gene for T7 RNA polymerase under control of the lacUV5 promoter. IPTG is required to maximally induce expression of the T7 RNA polymerase in order to express recombinant genes cloned downstream of a T7 promoter. BL21(DE3) is suitable for expression from a T7 or T7-lac promoter or promoters recognized by the E. coli RNA polymerase: e.g. lac, tac, trc, ParaBAD, PrhaBAD and also the T5 promoter. The genotype of BL21 (DE3) is: fhuA2 [lon] ompT gal (λ DE3) [dcm] ΔhsdSλ DE3=λ sBamHIo ΔEcoRI-B int::(lacI::PlacUV5::T7 gene1) i21 Δnin5.

BL21-AI E. coli contains a chromosomal insertion of the gene encoding T7 RNA polymerase (RNAP) into the araB locus of the araBAD operon, placing regulation of T7 RNAP under the control of the arabinose-inducible araBAD promoter. Therefore, this strain is especially useful for the expression of genes that may be toxic to other BL21 strains where basal expression of T7 RNAP is leaky. The BL21-AI strain does not contain the Ion protease and is deficient in the outer membrane protease, OmpT. The genotype of BL21-AI is F⁻ ompT hsdS_{B} (r_{B}⁻ m_{B}⁻) gal dcm araB::T7RNAP-tetA. The BL21-AI has an arabinose promoter that controls the production T7 RNA Polymerase, while the BL21 (DE3) has a lac promoter that controls the production of the T7 RNA Polymerase. This is significant because the lac promotion system is leaky. Therefore, the BL21-AI protein production is more tightly regulated due to the arabinose promotion system.

The present disclosure teaches that LPS (Lipopolysaccharide) modified BL21 (DE3) cells can be used. The LPS of the E. Coli is modified to be significantly less toxic. This LPS modified BL21 (DE3) cells if necessary. This could also be branched out to other gram-negative bacterial cells. Safe usage of gram-negative cells can be beneficial for anucleated cell-based platform and/or an agricultural formulation.

ClearColi® BL21(DE3) cells are the commercially available competent cells with a modified LPS (Lipid IVA) that does not trigger the endotoxic response in diverse cells. For example, ClearColi cells lack outer membrane agonists for hTLR4/VID-2 activation; therefore, activation of hTLR4/MD-2 signaling by ClearColi® is several orders of magnitude lower as compared with E. coli wild-type cells. Heterologous proteins prepared from ClearColi® are virtually free of endotoxic activity. After minimal purification from ClearColi cells, proteins or plasmids (which may contain Lipid IVA) can be used in most applications without eliciting an endotoxic response in human cells. In ClearColi cells, two of the secondary acyl chains of the normally hexa-acylated LPS have been deleted, eliminating a key determinant of endotoxicity in eukaryotic cells. The six acyl chains of the LPS are the trigger which is recognized by the Toll-like receptor 4 (TLR4) in complex with myeloid differentiation factor 2 (MD-2), causing activation of NF-κB and production of proinflammatory cytokines. The deletion of the two secondary acyl chains results in lipid IVA, which does not induce the formation of the activated heterotetrameric TLR4/MD-2 complex and thus does not trigger the endotoxic response. In ClearColi® BL21(DE3) Electrocompetent Cells 4 MA145 Rev. 31 Oct. 2016 addition, the oligosaccharide chain is deleted, making it easier to remove the resulting lipid IVA from any downstream product.

In some embodiments, protease-deficient minicells disclosed herein are produced from protease-deficient parental strains including, but are not limited to, BL21 (DE3), BL21-AI and LPS-modified BL21 (DE3). In other embodiments, BL21 (DE3), BL21-AI and LPS-modified BL21 (DE3) strains are genetically engineered by deleting, mutating, knocking out, or disrupting minC, minD, and/or minC and minD gene(s) to induce minicell production. In other embodiments, BL21 (DE3), BL21-AI and LPS-modified BL21 (DE3) strains are genetically engineered by overexpressing ftsZ and/or minE genes to induce minicell production.

In further embodiments, the present disclosure provides a new minicell-producing strain named as B8. This strain is the protease-deficient minicell-producing strain without the T7 RNA Polymerase. This minicell strain is produced from the BL21 (DE3) strain. While knocking out minC/D/CD, the T7 RNA Polymerase was silenced due to the homology of the introduced knockout via Lambda Red Transformation. This strain can be used for a need of a protease-deficient minicell, but not having the T7 RNA Polymerase. In some embodiments, minicells displayed an enzymatically active polypeptide such as complicated or toxic proteins on their surface, need to be more controlled and slower expression of the desired but complicated or toxic proteins.

The present disclosure teaches genotypes of newly-generated protease-deficient minicell strains comprising i) minC-deleted BL21(DE3); fhuA2 [lon] ompT gal (λ DE3) [dcm] ΔhsdSλ DE3=λ sBamHIo ΔEcoRI-B int::(lacI::PlacUV5::T7gene1) i21 Δnin5 ΔminC, ii) minD-deleted BL21(DE3); fhuA2 [lon] ompT gal (λ DE3) [dcm] ΔhsdS λ DE3 λ sBamHIo ΔEcoRI-B int::(lacI:PlacUV5::T7 gene1) i21 Δnin5 ΔminD, iii) minC/D-deleted BL21(DE3); fhuA2 [lon] ompT gal (λ DE3) [dcm] ΔhsdS λ DE3=λ sBamHIo ΔEcoRI-B int::(lacI::PlacUV5::T7 gene1) i21 Δnin5 ΔminC ΔminD; iv) minC-deleted BL21-AI; F⁻ ompT hsdS_{B} (r_{B}⁻ m_{B}⁻) gal dcm araB::T7RNAP-tetA ΔminC, v) minD-deleted BL21-AI; F⁻ ompT hsdS_{B} (r_{B}⁻ m_{B}⁻) gal dcm araB::T7RNAP-tetA ΔminD, vi) minC/D-deleted BL21-AI; F⁻ ompT hsdS_{B} (r_{B}⁻ m_{B}⁻) gal dcm araB::T7RNAP-tetA ΔminC ΔminD; vii) minC-deleted LPS-modified BL21(DE3); msbA148 ΔgutQ ΔkdsD ΔlpxL ΔlpxM ΔpagP ΔlpxP ΔeptA ΔminC, viii) minD-deleted LPS-modified BL21(DE3); msbA148 ΔgutQ ΔkdsD ΔlpxL ΔlpxM ΔpagP ΔlpxP ΔeptA ΔminD, ix) minC/D-deleted LPS-modified BL21(DE3); msbA148 ΔgutQ ΔkdsD ΔlpxL ΔlpxM ΔpagP ΔlpxP ΔeptA ΔminC, ΔminD, x) minC-deleted B8 with suppression on T7 RNA polymerase activity; fhuA2 [lon] ompT gal (λ DE3) [dcm] ΔhsdSλ DE3=λ sBamHIo ΔEcoRI-B int::(lacI::PlacUV5::T7 gene1) i21 Δnin5 ΔminC; xi) minD-deleted B8 with suppression on T7 RNA polymerase activity; fhuA2[lon] ompT gal(DE3) [dcm] ΔhsdS λ DE3=λ sBamHIo ΔEcoRI-B int::(lacI::PlacLUV5::T7 gene1) i21 Δnin5 ΔminD; and xii) minC/D-deleted B8 with suppression on T7 RNA polymerase activity; fhuA2 [lon] ompT gal (λ DE3) [dcm] ΔhsdSλ DE3=λ sBamHIo ΔEcoRI-B int::(lacI::PlacUV5::T7 gene1) i21 Δnin5 ΔminC ΔminD.

Minicells that have segregated from parent cells lack chromosomal and/or nuclear components, but retain the cytoplasm and its contents, including the cellular machinery required for protein expression. In some embodiments, minicells are protease-deficient because the parent cells are protease-deficient strains. Although chromosomes do not segregate into minicells, extrachromosomal and/or episomal genetic expression elements may segregate, or may be introduced into minicells after segregation from parent cells. In some embodiments, the disclosure is drawn to protease-deficient minicells comprising an expression element, which may be an inducible expression element. The inducible expression element such as an inducible promoter can be introduced to a recombinant plasmid used for homologous recombination to knock out and/or delete gene(s) involved to cell division and/or chromosomal partitioning such as minC, minD, and minC/D, a recombinant expression vector to overexpress gene(s) involved to cell division and/or chromosomal partitioning such as ftsZ and minE, and a recombinant expression vector for expressing an enzymatically active polypeptide including a protein of interest disclosed herein. In further embodiments, the inducible expression element comprises expression sequences operably linked to an open reading frame (ORF) that encodes proteins of interest disclosed herein. Optionally, at any point in the method, an inducing agent is provided in order to induce expression of an ORF that encodes proteins of interest disclosed herein.

In some embodiments, the disclosure teaches methods of making a protease-deficient bacterial minicell comprising a recombinant fusion protein that is not naturally found in parental cells. In some embodiment, the disclosure teaches method of preparing protease-deficient minicells from the host cells.

In other embodiments, the present disclosure teaches production of protease-deficient minicells from B. subtilis strains such as CU403 DIVIVA, CU403, DIVIVB,SPO-, CU403,DIVIVB and CU403,DIVIVB1 using by deleting, mutating, knocking out, or disrupting gene encoding WprA protease.

B. subtilis genetic manipulations work slightly differently than genetic manipulations in E. coli. B. subtilis is known to readily undergo homologous recombination if DNA containing homology to the existing genome is inserted. This is unlike E. coli; E. coli has mechanisms in place to degrade any non-natural linear DNA present. This difference can be utilized in order to knockout genes by designing an antibiotic resistance cassette flanked by homologous arms which correspond to the start and end of the gene that is desired to be knockout out.

The present disclosure provides the production of minicells from B. subtilis using genetically-engineering techniques. In some embodiments, B. subtilis strains including, but are not limited to CU403 DIVIVA (BGSC No. 1A196), CU403,DIVIVB,SPO- (BGSC No. 1A197), CU403,DIVIVB (BGSC No. 1A292), CU403,DIVIVB1 (BGSC No. 1A513), KO7 can be used as parental bacterial cells to produce minicells. B. subtilis strains are the commercially available and can be obtained from Bacillus Genetic Stock Center (BGSC). The catalog of strains is available on the document provided by publicly accessible BGSC webpage (www.bgsc.org/_catalogs/Catpart1.pdf).

In some embodiments, Bacillus Subtilis stains including, but are not limited to CU403 DIVIVA, CU403,DIVIVB,SPO-, CU403,DIVIVB and CU403,DIVIVB1 can be genetically modified by knocking out gene encoding WprA Protease in these strains. WprA protease is known as one of the harshest proteases.

In order to knock out, delete, and or remove WprA-encoding gene from B. subtilis strains, the pUC18 WprA-CamR vector is used. This vector has the homologous arms corresponding to the gene coding for WprA cell wall protease that naturally occurs in B. subtilis which is undesirable for protein surface expression. These homologous arms flank a chloramphenicol resistance cassette in order to allow for selection. After the homologous recombination via the homologous arms within the host cells, the WprA-encoding nucleotide except the homologous arm is replaced with the chloramphenicol selection marker gene. This plasmid can replicate within E. coli due to its origin of replication, thus when transformed into B. subtilis it cannot replicate. After transformation, colonies are selected for using chloramphenicol in order to isolate the colonies in which the knockout of WprA successfully occurs. Because the plasmid cannot replicate in B. subtilis, only the cells can survive against the presence of chloramphenicol if the recombinant cassette having the chloramphenicol resistant marker gene is integrated to the genome of the B. subtilis cell by homologous recombination.

B. subtilis secretes no fewer than seven proteases during vegetative growth and stationary phase. Strains in which multiple protease genes have been inactivated have proved to be superior to wild type strains in production of foreign proteins. The KO7 is prototrophic, free of secreted proteases, and have marker-free deletions in PY79 genetic background. This KO7 is available from the BGSC as accession number 1A1133. KO7 Genotype: ΔnprE ΔaprE Δepr Δmpr ΔnprB Δvpr Δbpr.

In some embodiments, a seven-protease deletion strain, B. subtilis KO7, can be used for B. subtilis minicell production by knocking out DIV-IVA and DIV-IVB using genetic engineering techniques described in the present disclosure.

In some embodiments, an anucleated cell is produced from a P678-54. E. coli wild strain. In other embodiments, an anucleated cell is produced from a protease-deficient E. coli strain including BL21, BL21(DE3), BL21-AI, LPS-modified BL21 (DE3) and B8. In some embodiments, an anucleated cell is produced from a parental bacterial cell deficient in WprA protease. In some embodiments, an anucleated cell is produced from a protease deficient B. subtilis parental bacterial cell. In some embodiments, an anucleated cell is produced from produced from a protease deficient KO7 B. subtilis parental bacterial cell. In other embodiments, an anucleated cell is produced from a protease deficient B. subtilis parental bacterial cell selected from the group consisting of: (1) CU403,DIVIVA; (2) CU403,DIVIVB,SPO-; (3) CU403,DIVIVB; and (4) CU403,DIVIVB1, wherein at least one protease encoding gene has been repressed, deleted, or silenced. In further embodiments, an anucleated cell is produced from an eukaryotic cell. In further embodiments, the anucleated cell produced as described above is used as an anucleated cell-based platform and/or an agricultural formulation for the encapsulation and delivery of biologically active compounds.

In some embodiments, minicells taught in the present disclosure is protease deficient or ribonuclease deficient. In some embodiments, said minicell is protease deficient. In some embodiments, said minicell is ribonuclease deficient. In some embodiments, said minicell is protease deficient and ribonuclease deficient.

### Ribonuclease-Deficient Bacterial Strains

The present disclosure provides the production of minicells from HT115 (DE3) using genetically-engineering techniques. HT115 (DE3) is a RNAi Feeding strain, which is an Rnase III-deficient E. coli strain with IPTG-inducible T7 Polymerase activity. To induce dsRNA production from these plasmids, the HT115 bacteria is grown on special RNAi NGM feeding plates that contain IPTG and the ampicillin analog carbenicillin. Carbenicillin is preferred over ampicillin because it tends to be more stable. Accordingly, HT115 strain as a ribonuclease-deficient strains can be utilized to create ribonuclease-deficient and/or ribonuclease-free minicells. The DE3 designation means that respective strains contain the λDE3 lysogen that carries the gene for T7 RNA polymerase under control of the lacUV5 promoter. IPTG is required to maximally induce expression of the T7 RNA polymerase in order to express recombinant genes cloned downstream of a T7 promoter. HT115 (DE3) is suitable for expression from a T7 or T7-lac promoter or promoters recognized by the E. coli RNA polymerase: e.g. lac, tac, trc, ParaBAD, PrhaBAD and also the T5 promoter. The genotype of HT115 (DE3) is: F-, mcrA, mcrB, IN(rrnD-rrnE)1, rncl4::Tn10(DE3 lysogen:lavUV5 promoter-T7 polymerase) (IPTG-inducible T7 polymerase) (RNAse III minus). This strain grows on LB or 2XYT plates. This strain is tetracycline resistant. Researchers using this strain can test for expression by transforming in one of the plasmids from the Fire Vector Kit (1999) (pLT76, e.g.) using standard CaCl₂) transformation techniques. This strain is resistant to tetracycline, and can be cultivated at 37° C., LB, and aerobic. Researchers also use this strain to test the interference experiment of nematodes.

In some embodiments, ribonuclease-deficient minicells disclosed herein are produced from ribonuclease-deficient parental strains including, but are not limited to, HT115 (DE3). In other embodiments, HT115 (DE3) strain is genetically engineered by deleting, mutating, knocking out, or disrupting minC, minD, and/or minC and minD gene(s) to induce minicell production. In other embodiments, HT115 (DE3) strain is genetically engineered by overexpressing ftsZ and/or minE genes to induce minicell production.

In some embodiments, ribonuclease-deficient minicells disclosed herein can be produced from protease-deficient parental strains including, but are not limited to, BL21 (DE3), BL21-AI and LPS-modified BL21 (DE3), genetically engineered by deleting, mutating, knocking out, or disrupting gene(s) encoding ribonuclease III. In other embodiments, BL21 (DE3), BL21-AI and LPS-modified BL21 (DE3) strains, in which ribonuclease III expression is suppressed, disrupted and/or nullified, are further genetically engineered by deleting, mutating, knocking out, or disrupting minC, minD, and/or minC and minD gene(s) to induce minicell production. In other embodiments, BL21 (DE3), BL21-AI and LPS-modified BL21 (DE3) strains, in which ribonuclease III expression is suppressed, disrupted and/or nullified, are also genetically engineered by overexpressing ftsZ and/or minE genes to induce minicell production.

The present disclosure teaches genotypes of newly-generated ribonuclease-deficient minicell strains comprising i) minC-deleted and ribonuclease III-deleted BL21(DE3); fhuA2 [lon] ompT gal (λ DE3) [dcm] ΔhsdSλ DE3=λ sBamHIo ΔEcoRI-B int::(lacI::PlacUV5::T7 gene1) i21 Δnin5 ΔminC rnc14::Tn10, ii) minD-deleted and ribonuclease III-deleted BL21(DE3); fhuA2 [lon] ompT gal (λ DE3) [dcm] ΔhsdS λ DE3 A sBamHIo ΔEcoRI-B int::(lacI::PlacUV5::T7 gene1) i21 Δnin5 ΔminD rnc14::Tn10, iii) minC/D-deleted and ribonuclease III-deleted BL21(DE3); fhuA2 [lon] ompT gal (λ DE3) [dcm] ΔhsdS λ DE3=λ sBamHIo ΔEcoRI-B int::(lacI::PlacUV5::T7 gene1) i21 Δnin5 ΔminC ΔminD rnc14::Tn10, iv) minC-deleted and ribonuclease III-deleted BL21-AI; F⁻ ompT hsdS_{B} (r_{B}⁻ m_{B}⁻) gal dcm araB::T7RNAP-tetA ΔminC rnc14::Tn10, v) minD-deleted and ribonuclease III-deleted BL21-AI; F-ompT hsdS_{B} (r_{B}⁻ m_{B}⁻) gal dcm araB::T7RNAP-tetA ΔminD rnc14::Tn10, vi) minC/D-deleted and ribonuclease III-deleted BL21-AI; F⁻ ompT hsdS_{B} (r_{B}⁻ m_{B}⁻) gal dcm araB::T7RNAP-tetA ΔminC ΔminD rnc14::Tn10; vii) minC-deleted LPS-modified and ribonuclease III-deleted BL21(DE3); msbA148 ΔgutQ ΔkdsD ΔlpxL ΔlpxM ΔpagP ΔlpxP ΔeptA ΔminC rnc14::Tn10, viii) minD-deleted LPS-modified and ribonuclease III-deleted BL21(DE3); msbA148 ΔgutQ ΔkdsD ΔlpxL ΔlpxM ΔpagP ΔlpxP ΔeptA ΔminD rnc14::Tn10, ix) minC/D-deleted LPS-modified and ribonuclease III-deleted BL21(DE3); msbA148 ΔgutQ ΔkdsD ΔlpxL ΔlpxM ΔpagP ΔlpxP ΔeptA ΔminC, ΔminD rnc14::Tn10, x) minC-deleted and ribonuclease III-deleted B8 with suppression on T7 RNA polymerase activity; fhuA2 [lon] ompT gal (λ DE3) [dcm] ΔhsdSλ DE3=λ sBamHIo ΔEcoRI-B int::(lacI:PlacUV5::T7 gene1) i21 Δnin5 ΔminC rnc14::Tn10; xi) minD-deleted and ribonuclease III-deleted B8 with suppression on T7 RNA polymerase activity; fhuA2 [lon] ompT gal (λ DE3) [dcm] ΔhsdSλ DE3=λ sBamHIo ΔEcoRI-B int::(lacI::PlacUV5::T7 gene1) 121 Δnin5 ΔminD rnc14::Tn10; xii) minC/D-deleted and ribonuclease III-deleted B8 with suppression on T7 RNA polymerase activity; fhuA2 [lon] ompT gal (λ DE3) [dcm] ΔhsdS λ DE3=λ sBamHIo ΔEcoRI-B int::(lacI::PlacUV5::T7 gene1) i21 Δnin5 ΔminC ΔminD rnc14::Tn10; xiii) minC-deleted HT115 (DE3); F-, mcrA, mcrB, IN(rrnD-rmE)1, rncl4::Tn10(DE3 lysogen: lavUV5 promoter-T7 polymerase) ΔminC, xiv) minD-deleted HT115 (DE3); F-, mcrA, mcrB, IN(rmD-rrnE)1, rncl4::Tn10(DE3 lysogen:lavUV5 promoter-T7 polymerase) ΔminD, and xv) minC/D-deleted HT115 (DE3); F-, merA, mcrB, IN(rrnD-rrnE)1, rncl4::Tn10(DE3 lysogen:lavUV5 promoter-T7 polymerase) ΔminC ΔminD.

Minicells that have segregated from parent cells lack chromosomal and/or nuclear components, but retain the cytoplasm and its contents, including the cellular machinery required for protein expression. In some embodiments, minicells are ribonuclease-deficient because the parent cells are ribonuclease-deficient strains. Although chromosomes do not segregate into minicells, extrachromosomal and/or episomal genetic expression elements may segregate, or may be introduced into minicells after segregation from parent cells. In some embodiments, the disclosure is drawn to ribonuclease-deficient minicells comprising an expression element, which may be an inducible expression element. The inducible expression element such as an inducible promoter can be introduced to a recombinant plasmid used for homologous recombination to knock out and/or delete gene(s) involved to cell division and/or chromosomal partitioning such as minC, minD, and minC/D, a recombinant expression vector to overexpress gene(s) involved to cell division and/or chromosomal partitioning such as ftsZ and minE, and a recombinant expression vector for expressing an enzymatically active polypeptide including a protein of interest disclosed herein. In further embodiments, the inducible expression element comprises expression sequences operably linked to an open reading frame (ORF) that encodes proteins of interest disclosed herein. Optionally, at any point in the method, an inducing agent is provided in order to induce expression of an ORF that encodes proteins of interest disclosed herein.

In some embodiments, the disclosure teaches methods of making a ribonuclease-deficient bacterial minicell comprising a recombinant fusion protein that is not naturally found in parental cells. In some embodiment, the disclosure teaches method of preparing ribonuclease-deficient minicells from the host cells.

In further embodiments, an anucleated cell is produced from an eukaryotic cell. In further embodiments, the anucleated cell produced as described above is used as an anucleated cell-based platform and/or an agricultural formulation for the encapsulation and delivery of biologically active compounds.

In some embodiments, minicells taught in the present disclosure is protease deficient or ribonuclease deficient. In some embodiments, said minicell is protease deficient. In some embodiments, said minicell is ribonuclease deficient. In some embodiments, said minicell is protease deficient and ribonuclease deficient. In some embodiments, said minicell is ribonuclease-deficient, and wherein said biologically active compound is a nucleic acid. In some embodiments, said biologically active compound is said nucleic acid is selected from the group consisting of an antisense nucleic acid, a double-stranded RNA (dsRNA), a short-hairpin RNA (shRNA), a small-interfering RNA (siRNA), a microRNA (miRNA), a ribozyme, an aptamer, and combination thereof

### Minicell Separation and Purification

A variety of methods are used to separate minicells from parent cells (i.e., the cells from which the minicells are produced) in a mixture of parent cells and minicells. In general, such methods are physical, biochemical and genetic, and can be used in combination.

Physical Separation of Minicells from Parent Cells

By way of non-limiting example, minicells are separated from parent cells glass-fiber filtration (Christen et al., Gene 23:195-198, 1983), and differential and zonal centrifugation (Barker et al., J. Gen. Microbiol. 111:387-396, 1979), size-exclusion chromatography, e.g. gel-filtration, differential sonication (Reeve, J. N., and N. H. Mendelson. 1973. Biochem. Biophys. Res. Commun. 53:1325-1330), and UV-irradiation (Tankersley, W. G., and J. M. Woodward. 1973. Proc Soc Exp Biol Med. 1974 March; 145(3):802-805).

Some techniques involve different centrifugation techniques, e.g., differential and zonal centrifugation. By way of non-limiting example, minicells may be purified by the double sucrose gradient purification technique described by Frazer and Curtiss, Curr. Topics Microbiol. Immunol. 69:1-84, 1975.

Other physical methods may also be used to remove parent cells from minicell preparations. By way of non-limiting example, mixtures of parent cells and minicells are frozen to −20° C. and then thawed slowly (Frazer and Curtiss, Curr. Topics Microbiol. Immunol. 69:1-84, 1975).

Biochemical Separation of Minicells from Parent Cells

Contaminating parental cells may be eliminated from minicell preparations by incubation in the presence of an agent, or under a set of conditions, that selectively kills dividing cells. Because minicells can neither grow nor divide, they are resistant to such treatments.

Examples of biochemical conditions that prevent or kill dividing parental cells is treatment with an antibacterial agent, such as penicillin or derivatives of penicillin. Penicillin has two potential affects. First, penicillin prevent cell wall formation and leads to lysis of dividing cells. Second, prior to lysis dividing cells form filaments that may assist in the physical separation steps described above. In addition to penicillin and its derivatives, other agents may be used to prevent division of parental cells. Such agents may include azide. Azide is a reversible inhibitor of electron transport, and thus prevents cell division. As another example, D-cycloserine or phage MS2 lysis protein may also serve as a biochemical approach to eliminate or inhibit dividing parental cells. (Markiewicz et al., FEMS Microbiol. Lett. 70:119-123, 1992). Khachatourians (U.S. Pat. No. 4,311,797) states that it may be desirable to incubate minicell/parent cell mixtures in brain heart infusion broth at 36° C. to 38° C. prior to the addition of penicillin G and further incubations.

Genetic Separation of Minicells from Parent Cells

Alternatively or additionally, various techniques may be used to selectively kill, preferably lyse, parent cells. For example, although minicells can internally retain M13 phage in the plasmid stage of the M13 life cycle, they are refractory to infection and lysis by M13 phage (Staudenbauer et al., Mol. Gen. Genet. 138:203-212, 1975). In contrast, parent cells are infected and lysed by M13 and are thus are selectively removed from a mixture comprising parent cells and minicells. A mixture comprising parent cells and minicells is treated with M13 phage at an M.O.I.=5 (phage cells). The infection is allowed to continue to a point where ≥50% of the parent cells are lysed, preferably ≥75%, more preferably ≥95% most preferably ≥99%; and ≤25% of the minicells are lysed or killed, preferably ≤15%, most preferably ≤1%.

As another non-limiting example of a method by which parent cells can be selectively killed, and preferably lysed, a chromosome of a parent cell may include a conditionally lethal gene. The induction of the chromosomal lethal gene will result in the destruction of parent cells, but will not affect minicells as they lack the chromosome harboring the conditionally lethal gene. As one example, a parent cell may contain a chromosomal integrated bacteriophage comprising a conditionally lethal gene. One example of such a bacteriophage is an integrated lambda phage that has a temperature sensitive repressor gene (e.g., lambda cI857). Induction of this phage, which results in the destruction of the parent cells but not of the achromosomal minicells, is achieved by simply raising the temperature of the growth media. A preferred bacteriophage to be used in this method is one that kills and/or lyses the parent cells but does not produce infective particles. One non-limiting example of this type of phage is one that lyses a cell but which has been engineered to as to not produce capsid proteins that are surround and protect phage DNA in infective particles. That is, capsid proteins are required for the production of infective particles.

As another non-limiting example of a method by which parent cells can be selectively killed or lysed, toxic proteins may be expressed that lead to parental cell lysis. By way of non-limiting example, these inducible constructs may employ a system to control the expression of a phage holing gene. Holin genes fall with in at least 35 different families with no detectable orthologous relationships (Grundling, A., et al. 2001. Proc. Natl. Acad. Sci. 98:9348-9352) of which each and any may be used to lyse parental cells to improve the purity of minicell preparations.

In some embodiments, minicells are substantially separated from the minicell-producing parent cells in a composition comprising minicells. After separation, the compositions comprising the minicells is at least about 99.9%, about 99.8%, about 99.7%, about 99.6%, about 99.5%, about 99.4%, about 99.3%, about 99.2%, about 99.1%, about 99%, about 98%, about 97%, about 96%, about 95%, about 94%, about 93%, about 92%, about 91%, about 90%, about 89%, about 88%, about 87%, about 86%, about 85%, about 84%, about 83%, about 82%, about 81%, about 80%, about 79%, about 78%, about 77%, about 76%, about 75%, about 74%, about 73%, about 72%, about 71%, about 70%, about 65%, about 60%, about 55%, about 50%, about 45%, about 40%, about 35%, about 30%, about 25% or about 20% free of minicell-producing parent cells. Thus, the compositions of the disclosure can comprise minicells that are substantially free of the parental cell.

In some aspects, the present invention provides a method for making minicells, the method comprising (a) culturing a minicell-producing parent cell, wherein the parent cell comprises an recombinant construct, wherein the recombinant construct comprises a nucleotide sequence homologous to a target gene associated with regulating cell division, and (b) separating the minicells from the parent cell, thereby generating a composition comprising minicells. In some embodiments, the method further comprises (c) purifying the minicells from the composition by centrifugation and/or filtration. In some embodiments, one or more additional expression constructs can be introduced into the minicell-producing parent cell which comprise genes associated with cell division. In such instances, the expression constructs may be simultaneously or sequentially introduced into the parent cell prior to induction for minicell formation, and can comprise one or more selection markers (e.g., antibiotic resistance genes) and/or reporter genes to allow for selection and/or visualization of minicells expressing the protein(s) of interest. In other embodiments, the expression construct can express one or more additional proteins, which are driven by the same or different promoters, including inducible promoters. In further embodiments, genes associated with cell division are minC, minD, and/or both minC and minD.

### Encapsulation

Encapsulation is a process of enclosing the substances within an inert material, which protects from environment as well as control release of active compounds. Two type of encapsulation has been well studies; 1) Nanoencapsulation that is the coating of various substances within another material at sizes on the nano scale, and 2) Microencapsulation that is similar to nanoencapsulation aside from it involving larger particles and having been done for a greater period of time than nanoencapsulation. Encapsulation is a new technology that has wide applications in pharmaceutical industries, agrochemical, food industries and cosmetics. In some embodiments, at least one biologically active compound described herein is inert to a cell other than a cell of a target.

In some embodiments, an anucleated cell-based platform and/or an agricultural formulation comprising eubacterial, archaebacterial, and eukaryotic cells is utilized to produce to encapsulate biologically active compounds. The bacterial cells including gram-negative bacteria, gram-negative bacteria, and Extremophilic bacteria, can produce the platform, which can encapsulate the desired biologically active compounds. The anucleated cells comprises minicells that are produced from parental bacterial cells disclosed herein naturally and/or by genetic engineering techniques taught herein.

The present disclosure teaches the benefit of using bacterial minicells which simplify purification of anucleated cell-based platform and reduce costs of encapsulation thereof. By employing encapsulation to biologically active compounds, the compounds are protected from external factors that causes degradation of the compounds and reduces life cycle of the compounds.

Current encapsulation techniques include oils, invert suspensions, polymer-based nanomaterials, lipid-based nanomaterials, porous inorganic nanomaterials, and clay-based nanomaterials.

COC (Crop Oil Concentrate) and MSO (Methylated Seed Oil) technologies are used for oil encapsulation. They act as humectants to move the active ingredient droplets through the spray nozzle and reconfigure the droplets on the outside to keep the active ingredients from evaporating.

Invert suspension is an oil sub-category providing either a suspension of water encapsulated within an oil shell or water surrounded by an oil coating used to minimize the creation of driftable fines (sub 105 microns) after being sprayed through a nozzle tip. This technology works on reducing driftable fines for the active ingredients.

Polymer-based nanomaterials consist of a polymer that has nanoparticles or nanofillers dispersed within the polymer matrix. Typically, the polymers are contrasting (one hydrophobic, one hydrophilic) to sustain amphiphilic properties. Either synthetic or natural polymers (guar gum) act to increase the viscosity of the spray solution and affect the rheological profile by producing larger spray particles. Polymer-based adjuvants increase the possibility of spray particles shattering, increasing drift. However, use of polymer-based drift reduction technology adjuvants for aerial applications of active ingredients is not recommend. Although they have an efficient loading capacity, the necessary polymers are expensive, limiting scalability.

Lipid-based nanomaterials have great potential to encapsulate hydrophilic, hydrophobic, and lipophilic active ingredients, and are commonly used in the pharmaceutical field. However, scalable production is significantly limited by cost.

Porous inorganic nanomaterials, such as silica nanoparticles, are effective at encapsulating bioactive molecules, but face limitations in biodegradability and scalability. These polymer-coated nanoparticles suffer from various limitations such as poor thermal and chemical stability, rapid elimination by the plant enzyme system, and degradation of some polymers, resulting in the formation of acidic monomers and decreased pH value within the polymer matrix. Clay nanoparticles are economically viable and provide great opportunities for developing multifunctional nanocarrier materials, but are energy intensive, requiring high heat for production. These alternatives cannot be modified as easily to provide targeted delivery to plants.

In some embodiments, an anucleated cell-based minicell platform and/or an agricultural formulation has advantages in cost and biodegradability. The minicell platforms are easily scaled through common, industrial fermentation practices. Once scaled, they can be purified through a series of centrifugation and/or filtration steps. The self-assembly of the carbohydrate-binding modules to the surface of minicells significantly cuts the cost of making a targeting bioparticle. Additionally, an anucleated cell-based minicell platform is advantageous compared to other encapsulation technologies in terms of biocompatibility for plant and environmental use; this is because the anucleated cell-based minicell platform is derived by safe, commonly found microbes that are native to the applied areas and can safely biodegrade to be reused by the ecosystem. This platform suitable for scalable, non-toxic delivery can play an significant role in the field of agriculture.

In order to solve problems of conventional agrochemicals that are easily degraded or evaporated before they reach their intended target, the present disclosure provides an anucleated cell-based platform and/or an agricultural formulation for the encapsulation and delivery of biologically active compounds aims to protect the bioactivity from external factors until the compounds are applied to a target and to be slowly released to the intended target. The various mechanisms by which biologically active compounds are typically lost to the environment are averted using the disclosed minicell-based encapsulation and delivery platform. This is because the lipid-bilayer of the minicell acts as an effective layer of protection against harsh environmental conditions. Specifically, the internalization of the active inside of the minicell protects the compounds against sharp changes in temperature, pH, or strong exposure to light. In other words, the minicell protects the compounds against volatilization, photolytic degradation, and hydrolysis. Therefore, the biologically active compounds can remain protected from adverse external factors and is allowed for gradual and/or controlled release to intended targets via minicell-based platform that encapsulates the biologically active compound of interest.

Furthermore, the other benefit of the present disclosure provides an anucleated cell-based platform and/or an agricultural formulation for the encapsulation and delivery of biologically active compounds is that this platform offers the improved and enhanced targeting capability to the plant and its microenvironment. The inherent surface chemistry of the outer membrane of the minicell-based bioparticle naturally mimics that of bacteria. This is significant because there are many types of bacteria that live symbiotically in a microbiome on the surface of plant leaves, stems, and in their root system. By using the minicell-based platform, biological membrane of the minicell has natural adherence to the various surfaces of plants. This feature allows for delivering encapsulated biologically-active compounds including bioherbicides in the minicell chassis that is targeted to adhere to plant surfaces and the soil microenvironment around the plant's root system as well as to other targets such as pests, insects, bugs, weeds, worms, bacteria, viruses, pathogens, and parasites. In addition to relying on the natural adherence of the minicell-based bioparticle to plants, the present disclosure teaches uses of genetic engineering to give rise to surface-expressing moiety fused with specific binding domain on the membrane of the minicell. In this way its ability to target the plant or the pest is significantly enhanced.

In some embodiments, the present disclosure provides the genetic engineering techniques to make minicell-based platform with binding domains/motifs that functionalize the surface of the minicell. Proteins including specific binding domains and/or motifs are expressed on the surface of the minicells and specifically target binding sites that are present on the surface of plants or pests.

In some embodiments, minicell-based platform can be functionalized by proteins with carbohydrate binding modules (CBMs) that can target and bind to carbohydrates such as cellulose, xylan, chitin, and lignin, which are important and ubiquitous structural components of plant cell walls. Because CBMs can recognize their binding site present on a subject such as a plant or a pest, the minicell-based platform comprising the functionalized binding domain allows for targeting with high specificity.

In some embodiments, the use of CBMs is not limited to agriculture uses. CBMs can be used for the purification of active ingredients or biomolecules through the means of cellulose columns. Supplementary to the surface chemistry of the minicell-based platform, the relative mass of the bioparticle can also significantly mitigate the off-target exposure of active compounds due to aerosolization and leaching. By concentrating and encapsulating actives in the relatively large chassis of the minicell before being sprayed, the compound is less susceptible to aerosolization or drift caused by wind when compared to spraying free-floating compounds. Furthermore, the larger size of the minicell encapsulation and delivery platform can mitigate the leaching of actives through the soil and into groundwater supplies.

### Agriculturally Acceptable Carrier

Compositions described herein can comprise an agriculturally acceptable carrier. The composition useful for these embodiments may include at least one member selected from the group consisting of a tackifier, a microbial stabilizer, a fungicide, an antibacterial agent, a preservative, a stabilizer, a surfactant, an anti-complex agent, an herbicide, a nematicide, an insecticide, a plant growth regulator, a fertilizer, a rodenticide, a dessicant, a bactericide, a nutrient, or any combination thereof. In some examples, compositions may be shelf-stable. For example, any of the compositions described herein can include an agriculturally acceptable carrier (e.g., one or more of a fertilizer such as a non-naturally occurring fertilizer, an adhesion agent such as a non-naturally occurring adhesion agent, and a pesticide such as a non-naturally occurring pesticide). A non-naturally occurring adhesion agent can be, for example, a polymer, copolymer, or synthetic wax. For example, any of the coated seeds, seedlings, or plants described herein can contain such an agriculturally acceptable carrier in the seed coating. In any of the compositions or methods described herein, an agriculturally acceptable carrier can be or can include a non-naturally occurring compound (e.g., a non-naturally occurring fertilizer, a non-naturally occurring adhesion agent such as a polymer, copolymer, or synthetic wax, or a non-naturally occurring pesticide).

In some embodiments, an anucleated cell-based platform described herein can be mixed with an agriculturally acceptable carrier. The carrier can be a solid carrier or liquid carrier, and in various forms including microspheres, powders, emulsions and the like. The carrier may be any one or more of a number of carriers that confer a variety of properties, such as increased stability, wettability, or dispersability. Wetting agents such as natural or synthetic surfactants, which can be nonionic or ionic surfactants, or a combination thereof can be included in the composition. Water-in-oil emulsions can also be used to formulate a composition that includes the isolated bacteria (see, for example, U.S. Pat. No. 7,485,451). Suitable formulations that may be prepared include wettable powders, granules, gels, agar strips or pellets, thickeners, liquids such as aqueous flowables, aqueous suspensions, water-in-oil emulsions, etc. The formulation may include grain or legume products, for example, ground grain or beans, broth or flour derived from grain or beans, starch, sugar, or oil.

In some embodiments, the agricultural carrier may be soil or a plant growth medium. Other agricultural carriers that may be used include water, fertilizers, plant-based oils, humectants, or combinations thereof. Alternatively, the agricultural carrier may be a solid, such as diatomaceous earth, loam, silica, alginate, clay, bentonite, vermiculite, seed cases, other plant and animal products, or combinations, including granules, pellets, or suspensions. Mixtures of any of the aforementioned ingredients are also contemplated as carriers, such as but not limited to, pesta (flour and kaolin clay), agar or flour-based pellets in loam, sand, or clay, etc. Formulations may include food sources for the bacteria, such as barley, rice, or other biological materials such as seed, plant parts, sugar cane bagasse, hulls or stalks from grain processing, ground plant material or wood from building site refuse, sawdust or small fibers from recycling of paper, fabric, or wood.

Additional examples of agriculturally acceptable carriers include dispersants (e.g., polyvinylpyrrolidone/vinyl acetate PVPIVA S-630), surfactants, binders, and filler agents.

Persons having skill in the art will appreciate that, unless otherwise noted, all references to an anucleated cell-based platform in the present disclosure can be read as referring to an agricultural formulation. Therefore, embodiments described in the present disclosure which refer to an anucleated cell-based platform will also be understood to refer to an agricultural formulation.

### Binding Domain for Cell Adhesion

In some embodiments, the anucleated cell-based platform described herewith express binding domains. These domains allow for better retention of the minicells on plant surfaces, which prevents runoff or drift of biologically active compounds encapsulated within the minicells. They can also improve adhesion to the targeted pests to ensure the administration of an effective dose of the biologically active compounds. Once the minicells are on the plant, the chemical will slowly release into the environment.

In some embodiments, the anucleated cell described herewith expresses a fusion protein, which comprises at least one surface expressing moiety and at least one plant cell adhesion moiety. The plant cell adhesion moiety comprises a carbohydrate binding module comprising a carbohydrate binding module selected from the group consisting of: a cellulose binding domain, a xylan binding domain, a chitin binding domain, and a lignin binding domain.

In some embodiments, the anucleated cell expresses a polypeptide on its surface that increases adhesion to a plant surface. The polypeptide is a plant adhesion polypeptide on its surface. In some embodiments, the polypeptide is a carbohydrate binding module that is displayed on its surface. In other embodiments, the polypeptide is a cellulose binding domain that is displayed on its surface. In other embodiments, the polypeptide is a chitin binding domain that is displayed on its surface.

A carbohydrate-binding module (CBM) is a protein domain found in carbohydrate-active enzymes (for example glycoside hydrolases). The majority of these domains have carbohydrate-binding activity. Some of these domains are found on cellulosomal scaffoldin proteins. CBMs are also known as cellulose-binding domains. CBMs are classified into numerous families, based on amino acid sequence similarity. CBMs of microbial glycoside hydrolases play a central role in the recycling of photosynthetically fixed carbon through their binding to specific plant structural polysaccharides. CBMs can recognize both crystalline and amorphous cellulose forms. CBMs are the most common non-catalytic modules associated with enzymes active in plant cell-wall hydrolysis. Many putative CBMs have been identified by amino acid sequence alignments but only a few representatives have been shown experimentally to have a carbohydrate-binding function. By binding to polysaccharides, CBMs bring appended catalytic domains into intimate contact with target substrates and thus potentiate catalysis. CBMs with the capacity to bind cellulose are associated with enzymes that hydrolyze both cellulose and other cell wall polymers such as xylan, mannan, pectin, and noncellulosic β-glucans.

Cellulose binding domains (CBDs) have been described as useful agents for attachment of molecular species to cellulose (U.S. Pat. Nos. 5,738,984 and 6,124,117). Indeed, as cotton is made up of 90% cellulose, CBDs have proved useful for delivery of so called “benefit agents” onto cotton fabrics, as is disclosed in WO9800500 where direct fusions between a CBD and an enzyme were used utilizing the affinity of the CBD to bind to cotton fabric. The use of similar multifunctional fusion proteins for delivery of encapsulated benefit agents was claimed in WO03031477, wherein the multifunctional fusion proteins consist of a first binding domain which is a celllulose binding domain and a second binding domain, wherein either the first binding domain or the second binding domain can bind to a microparticle. WO03031477 is exemplified using a bifunctional fusion protein consisting of a CBD and an anti-RR6 antibody fragment binding to a microparticle, which complex is deposited onto cotton treads or cut grass.

In some embodiments, the enzymatically active polypeptide displayed by the minicells of the invention comprises a CBM. Exemplary CBM from Cellulomonas fimi that is within the scope of the disclosure is used. In some embodiments, the cell adhesion moiety is fused to surface-expressing moiety. In other embodiments, the CBM is fused to surface-expressing moiety and is displayed on the surface of the minicells.

### Surface Expression System

In some embodiments, the present disclosure teaches surface-expressing moiety that is fused to cell adhesion moiety. The surface-expressing moiety can be transmembrane protein and/or transmembrane domains that function as a linker protein to display the enzymatically active polypeptides having cell adhesion moiety on the surface of cells.

In some embodiments, surface-expressing moiety can be membrane-associated proteins including, but not limited to, transmembrane protein, membrane-anchoring protein, linker protein and/or domain thereof.

In some embodiments, the invention is drawn to display produced membrane-associated protein(s) fused to proteins of interest disclosed herein on the surface of the minicell. By way of non-limiting example, this structure may be an internally expressed membrane protein or chimeric construct to be inserted in or associated with the minicell membrane such that the extracellular domain or domain of interest is exposed on the outer surface of the minicell (expressed and displayed on the surface of the minicell or expressed in the parental cell to be displayed on the surface of the segregated minicell).

The displayed domain fused to a membrane-associated linker protein may be an cell adhesion domain including carbohydrate binding modules. In other embodiments.

Contacting such minicells with the appropriate substrate of the enzyme allows the substrate to be converted to reactant. When either the substrate or reactant is detectable, the reaction catalyzed by the membrane-bound enzyme may be quantified. In the latter instance, the minicells may be used to identify and isolate, from a pool of compounds, one or more compounds that inhibit or stimulate the activity of the enzyme represented by the displayed enzymatic moiety.

In some embodiments, the membrane-associated protein can be a fusion protein, i.e., a protein that comprises a first polypeptide having a first amino acid sequence and a second polypeptide having a second amino acid sequence, wherein the first and second amino acid sequences are not naturally present in the same polypeptide. At least one polypeptide in a membrane fusion protein is a “transmembrane protein/domain” “membrane-anchoring protein/domain” or “linker protein/domain”. The transmembrane and membrane-anchoring domains of a fusion protein may be selected from membrane proteins that naturally occur in a prokaryote such as bacteria, a eukaryote, such as a fungus, a unicellular eukaryote, a plant and an animal, such as a mammal including a human. Such domains may be from a viral membrane protein naturally found in a virus such as a bacteriophage or a eukaryotic virus, e.g., an adenovirus or a retrovirus. Such domains may be from a membrane protein naturally found in an archaebacterium such as a thermophile.

Exemplary surface-expressing moieties include but are not limited to ice nucleation protein (INP) Bordetella serum-resistance killing protein (BRK), Adhesin Involved in Diffuse Adherence protein (AIDA) and/or an exported bacterial protein. “Exported bacterial proteins,” generally refers to bacterial proteins that are transported across the plasma membrane and function as an anchor for membrane proteins. Exemplary exported bacterial proteins encompassed by the present invention, include, but are not limited to LamB (GenBank Accession No. AMC96895), OprF (GenBank Accession No. NP_792118), OmpA (GenBank Accession No. AIZ93785), Lpp (GenBank Accession No. P69776), MalE (GenBank Accession No. POAEX9), PhoA (GenBank Accession No. AIZ92470.1), Bla (GenBank Accession No. P62593), F1 or M13 major coat (J7I0P6—Uniprot No.), and F1 or M13 minor coat (P69168—Uniprot No.).

In some embodiments, for gram negative bacterial expression systems, enzymes of interest disclosed herein are immobilized to the surface of the minicells via wild type or mutant versions of the exported bacterial proteins such as LamB (lambda receptor), OprF (P. aeruginosa outer membrane protein F), OmpA (outer membrane protein A), Lpp (Lipoprotein), MalE (Maltose binding protein), PhoA (Alkaline phosphatase), Bla (TEM-1 B-lactamase), F1 or M13 major coat (derived from Gene VIII), F1 or M13 minor coat (Gene III).

In other embodiments, a wild type and/or truncated version of the Ice Nucleation Protein (INP) can be used to immobilize enzymes on the surface of bacteria.

### Release of Biologically Active Compounds Encapsulated by Minicell

The present disclosure teaches that biologically active compounds are retained within the minicell and be released over time. The disclosure teaches a high value, low volume product of an anucleated minicell encapsulating at least one biologically active compounds and/or expressing a fusion protein. In some embodiments, the fusion protein has at least one surface expressing moiety and at least one cell adhesion moiety. In some embodiments, the fusion protein has at least one surface expressing moiety and at least one cell stimulation moiety. In some embodiments, the fusion protein has at least one surface expressing moiety and at least one cell degrading moiety. In some embodiments, the anucleated cell-based product can be sprayed much less than other commercially available agrochemical products and also retain the desired effects of the active compounds over a longer period of time.

The term “controlled release” as used herein means that one or more biologically active compounds encapsulated by an anucleated cell described in the present disclosed are released over time in a controlled manner. The controlled release is meant for purposes of the present disclosure that, once the biologically active compound is released from the formulation, it is released at a controlled rate such that levels and/or concentrations of the compounds are sustained and/or delayed over an extended period of time from the start of compound release, e.g., providing a release over a time period with a prolonged interval.

Current controlled release mechanism of agrochemical is based mainly on fully encapsulation of fertilizer (e.g. Agrium, ICL, Kingenta and Ekompany) or pesticides (e.g. Adama, Syngenta, Bayer). Fully encapsulation of fertilizer is usually based on resins (e.g. polyurethanes) or sulfur base mixture. Pesticides are loaded into micro polymeric capsules. Products of encapsulated fertilizer are limited to milligrams scale of dry fertilizer, due to the need of thick wall opposing the high inner pressure. This pressure is build up due to water entering the capsule driven by the negative osmotic potential of the dissolve fertilizer. As more fertilizer is encapsulated, more pressure will build up and a thicker wall is required. The feasible ratio between fertilizer amounts to wall thickness is in the tens of milligrams scale. Nevertheless encapsulated fertilizer is still very expensive and costs up to four times over the fertilizer price.

Moreover, the release mechanism is based on transport through faults and cracks distributed in the casing. Meaning, coating must be uniform throughout the all surface area, which is in turn a manufacturing challenge. On top of that, the materials being used for coating are temperature sensitive and change their structural properties extremely in small temperature range (17° C.-25° C.), leading to radical changes in release rates (up to double the rate). Thus, conventional encapsulation of agrochemicals has challenges of uniform coating and temperature dependent.

If it is desired to permit fast release of the encapsulated composition during drying of the formulation on a leaf, or similar, surface it is necessary to have thin walled microcapsules. Typically microcapsules with a mean diameter of about 2 microns require a polymer wall concentration in the formulation of about 3% by weight. Greater quantities of polymer will slow the release rate. The diameter of the capsules and the quantity of wall forming polymer can be used to tune the performance of the capsules, depending on the required pesticide and the conditions of use.

The increasing use of agrochemicals such as pesticides, herbicides, fungicides, insecticides, nematicides, fertilizer and the like, poses serious health and environmental problems which must be controlled in order to minimize the harmful effects of those products. One problem frequently encountered with herbicides, such as alachlor, metolachlor, norflurazon and sulfometuron is leaching and migration, which results in loss of herbicidal efficiency and can cause damage to other crops and contaminate water.

The present disclosure teaches that biologically active compounds encapsulated by minicells disclosed herein can be released in a controlled manner. In some embodiments, the controlled release of the compounds are determined by a treatment of an agent such as glutaraldehyde, formaldehyde, as well as natural compounds, such as genipin, and epigallocatechin gallat, derivatives of ethylene glycol di(meth)acrylate, derivatives of methylenebisacrylamide, and formaldehyde-free crosslinking agent DVB (Divinyl Benzene). In some embodiments, a varying concentration of the agent (e.g. glutaraldehyde) can prevent the degradation of minicells encapsulating the biologically active compounds in different degrees.

In other embodiments, the agent includes, but is not limited to glutaraldehyde, formaldehyde, as well as natural compounds, such as genipin, and epigallocatechin gallat, derivatives of ethylene glycol di(meth)acrylate, derivatives of methylenebisacrylamide, and formaldehyde-free crosslinking agent DVB (Divinyl Benzene).

In some embodiments, biologically active compounds encapsulated by minicells disclosed herein can be released at a rate of 1%, 2%, 3%, 4%, 5%, 6%, 7%, 8%, 9%, 10%, 11%, 12%, 13%, 14%, 15%, 16%, 17%, 8%, %19%, 20%, 21%, 22%, 23%, 24%, 25%, 26%, 27%, 28% 29%, 30%, 31%, 32% 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95%, or 100% of a desired minicell unit/input per day. In other embodiments, an amount of the desired minicell unit/input accounts for encapsulated biologically active compounds. Encapsulation amount of biologically active compounds can calculate encapsulation fraction and mass fraction, which determines the desired minicell unit and/or input per day.

In some embodiments, minicells without treatment of an agent (e.g. glutaraldehyde) may have an initial fast release of 10%, 20%, 30%, 40%, 50%, 60%, 70%, or 80% of their desired unit/input per day and are followed by a controlled release of minicells treated with a varying concentration of the agent (e.g. glutaraldehyde), which give rise to a controlled release of 1%, 2%, 3% 4%, 5%, 6%, 7%, 8%, 9%, %, %11%, %12%, 13%, 14%, 15%, 16%, 17%, 18%, 19%, or 20% of the desired input per day. In some embodiments, a varying concentration of the agent (e.g. glutaraldehyde) can prevent the degradation of minicells encapsulating the biologically active compounds in different degrees. In some embodiments, the agent includes, but is not limited to glutaraldehyde, formaldehyde, as well as natural compounds, such as genipin, and epigallocatechin gallat, derivatives of ethylene glycol di(meth)acrylate, derivatives of methylenebisacrylamide, and formaldehyde-free crosslinking agent DVB (Divinyl Benzene).

### Improved Encapsulation and Retention

In order to improve encapsulation and retention, the present disclosure teaches that solvents can be used in the encapsulation solution to increase the solubility of the biologically active compounds in the minicells. These solvents include, but are not limited to, CaCl₂) solution, ethanol, DMSO, polyethylene glycol, and glycerol. Not only can these solvents be used to increase the solubility of certain active compounds, but they may be used to increase the diffusion of the active compounds into the cell through certain protein channels or through the lipid bilayer of the outer membrane. In addition to the use of solvents to enhance the encapsulation process of the anucleated cell-based platform, certain fixatives, preservatives, and cross-linking agents can be used to trap the active ingredient within the membrane of the minicell, cross-link certain active compounds to the minicell itself, and improve the stability of the minicell. The relative concentration of these stabilizing/cross-linking agents can be tuned to achieve the required loading capacity for the active ingredient as well as the release kinetics of the active ingredient from the cell. These agents include, but are not limited to synthetic compounds, such as glutaraldehyde, formaldehyde, as well as natural compounds, such as genipin, and epigallocatechin gallat.

In some embodiments, minicells described herein are treated with a solvent, agent, fixative, preservative, or cross-linking agent for better solubility, increased stability, or enhanced integrity. In some embodiments, said minicell exhibits a controlled release rate of said biologically active compound, wherein the release can be a steady release or an initial burst followed by steady release.

In other embodiments, minicells can show their innate and modified stability and can withstand various environmental conditions and changes in temperature, pH, and/or shear stress.

### Invasive Delivery

The present disclosure teaches an invasive delivery method of biologically active compounds into a target cell, which is not a mammalian cell by application of an agent that can help improve penetration of the minicell into targets such as plants, pests, insects, bugs, worms, pathogens and parasites. The anucleated minicells encapsulating the biologically active compounds described herein is applied to a target cell with an agent. In some embodiments, the agent is an adjuvant for improving penetration of the anucleated minicell into the target cell and invasively delivering the biologically active compounds within the target cell. The agent is a surfactant, an emulsifier, a crop oil concentrate, a penetrant, a salt or combination thereof. Not-limiting examples of the agent are methylated seed oil, N,N-dimethyldecanamide, and N-decyl-N-methly formaide. In some embodiments, a method of delivering at least one biologically active compound is provided, comprising: applying said minicell to said target cell with an agent, wherein said agent is an adjuvant for improving penetration of minicells into a target cell. In further embodiments, a method of delivering at least one biologically active compound is provided, said agent is a surfactant, an emulsifier, a crop oil concentrate, a penetrant, a salt or combination thereof.

Various surfactants and other formulation additives can be used to enhance the uptake/invasiveness of nanoparticles or compounds into plants through the roots and leaves. Silicone surfactants can enhance the uptake of compounds and nanoparticles through the stomata, cuticle, and root system. Lipid-based liquid crystalline nanoparticles can be used as a surfactant to improve delivery of biologically active compounds through the cuticle layer.

In other embodiments, the present disclosure teaches an invasive delivery method of biologically active compounds into a target cell by expressing proteins that improve penetration of plant surface or increase uptake through the roots or stomata. In some embodiments, the minicells express at least one fusion protein comprises at least one surface expressing moiety and at least one target cell degradation moiety. The target cell degradation moiety comprises an cutinase and cellulose, which can facilitate minicells to pass through plant surface and deliver biologically active compounds into a target cell, tissue or organ.

In some embodiments, the intact anucleated cell expresses a cutinase on its surface that facilitate said anucleated cell to penetrate through a plant cuticle into the target cell. The intact anucleated cell expresses a heterologous cutinase that is displayed on its surface. The intact anucleated cell expresses a cellulase on its surface that breaks down a target cell wall and facilitate said anucleated cell to penetrate into the target cell. The intact anucleated cell expresses a heterologous cellulase that is displayed on its surface.

In further embodiments, the present disclosure teaches an invasive delivery method of biologically active compounds into a target cell, which is not a mammalian cell, by generating minicells from plant invasive species such as Agrobacterium and Endophytes.

The present disclosure provides compositions and methods of producing minicells from plant pathogenic bacteria and fungi such as endophytes. The bacterial and/or yeast species has mechanisms to transport itself from the environment to the cells, internal tissues or organs of target plants. In some embodiments, minicells from these bacterial and yeast endophytes are produced. The endophytes used for minicell production include, but are not limited to Acidovorax facilis, Bradyrhizobium, Rhizobium, Rhodococcus rhodochrous, Colletotrichum, Curvularia, Epichloi, Fusarium, Mycosphaerella, Neotyphodium, Piriformospora, Serendipita. The minicells derived from endophytes can encapsulate biologically active compounds described herein and deliver them into the internal parts of target plants by invasion/penetration mechanisms.

There are several pathways by which biologically active compounds or particles are able to be uptaken through the leaf. These pathways include through trichomes, stomata, plant wounds, root junctions, stigma, and the cuticle (Alshaal et al., Env. Biodiv. Soil Security 1:71-83, 2017). Due to the extensive presence of the cuticle at the outermost layer of plant leaves, a primary manner in which foliar uptake occurs is through the cuticle layer. Various compounds, both lipophilic and hydrophilic, are able to transport across the cuticle through aqueous pores (for polar compounds) or cutin matrices (for apolar compounds) (Wang et al., Pestcide Biochemistry and Physiology, 87(1):1-8, 2007). It has been reported that all kinds of nanoparticles, from negatively charged silica nanoparticles (20 nm) to lipid-based liquid crystalline NPs (150-300 nm), have been shown to accumulate above actinal cell walls and in the cuticle (Schwab et al., J of Nanotoxicology 10(3):257-278, 2016). There are permeable regions of the cuticle, such as trichomes, hydathodes, or cell junctions, in plant tissue that have also have uptake functions.

On the other hand, plants are able to uptake compounds and nanoparticles through the stomata. The ability for uptake through the stomata varies for each plant species, but the stomata has generally shown to have a high transport velocity into the leaf, especially for particles or compounds less than 10 nm. However, it is also the case that larger nanoparticles have been able to enter the plant through stomata openings. Foliar application of nanoparticles has been shown to lead to translocation of nanoparticle from stomatal cavities to plant tissues, the vasculature, and roots cuticle (Schwab et al., J of Nanotoxicology 10(3):257-278, 2016). Bacteria (which are larger than minicells) are also able to invade plants through stomata openings, often times regulating their openings using virulence factors (Zeng et al., Curr. Opin. Biotechnol. 21(5):599-603, 2010). In some embodiments, minicells disclosed herein can be uptaken to target plants and translocated to target cells when the minicells encapsulating biologically active compounds are applied to leaves of target plants.

Agricultural applications of agrochemicals or nanoparticles in soil can be very effective since nanoparticles generally accumulate in the first few meters or centimeters of the soil and therefore, interact closely with the rhizosphere. Many studies have shown that nanoparticles are able to accumulate and aggregate near the roots, root tips, root caps, and mucilage of plants. It has also been shown that the mucilage, exudates, and exDNA of plants around its root system serves as a “trap” that immobilizes some nanoparticles and bacteria. Furthermore, plant roots have been shown to be able to uptake and absorb a variety of compounds and nanoparticles into the plant vasculature and tissue (Schwab et al., J of Nanotoxicology 10(3):257-278, 2016). In some embodiments, minicells disclosed herein can be uptaken to target plants and translocated to target cells when the minicells encapsulating biologically active compounds are applied to soil and/or roots of target plants.

Once these compounds and/or nanomaterials have successfully invaded the plant and are in proximity to the plant cell membranes, they can undergo a process of endocytosis. The plant cell membrane uptakes extracellular material, including nanoparticles, through endocytosis. Nanoparticles, up to 500 nm and regardless of charge, can enter the plant cell through endocytosis. Alternative pathways for nanoparticles and other compounds into plant cells are through the permeable pathways of the cell membrane themselves. One of these pathways, aquaporins, allows for non-ionic, solutes to be non-selectively be uptaken into plant cells. In some embodiments, at least one biologically active compound is delivered into a target cell, which is not a mammalian cell, when the anucleated minicell described herein is applied by endocytosis. In some embodiments, minicells descried herein are applied to a target and delivered into a cell of a target by endocytosis.

### Target

As used herein, the term “target” is intended to include any target surface to which a biologically active compound alone, a minicell, an agricultural formulation or an anucleated cell-based platform encapsulating a biologically active compound of the present disclosure may be applied to a plant or a pest. For example to a plant, plant material including roots, bulbs, tubers, corms, leaves, flowers, seeds, stems, callus tissue, nuts, grains, fruit, cuttings, root stock, scions, harvested crops including roots, bulbs, tubers, corms, leaves, flowers, seeds, stems, callus tissue, nuts, grains, fruit, cuttings, root stock, scions, or any surface that may contact harvested crops including harvesting equipment, packaging equipment and packaging material.

The term “target cell” refers to cells that is a component of each target.

In some embodiments, exemplary target plants, which are undesired/undesirable weeds, according to certain embodiments of the present disclosures, include but not limited to crabgrass, clover, mustard, wild mustard, dandelion, black medic, bellflower, daisy, plantain, Bermuda grass, blue grass, and Canadian thistle. In some embodiments, target plants are annual and/or perennial weeds.

The present disclosure teaches that a target cell comprises a plant cell, an insect cell, a worm cell, a bacterial cell, a fungal cell, and a virus. In some embodiments, the target cell is a cell of undesired/undesirable plants.

The present disclosure provides that the bioactive agent alone or the anucleated cell-based platform and/or agricultural formulation encapsulating the bioactive agent described herein, is targeted to a plant, an insect, a worm, a bacterium, a fungus, and a virus. In some embodiments, the target plant is an undesired/undesirable weed.

### Enhancement of Activities of Bioactive Agent

The present disclosure teaches agricultural compositions and methods for controlling growth of one or more plant species. The present disclosure provides the suppressing, inhibiting, limiting, killing or negatively controlling growth of one or more undesirable plant species such as weeds. Also, The present disclosure provides the augmenting of the phenotype or genotype of a plant, stimulating a positive response to, or positively controlling one or more desirable plant species, thereby germinating, growing vegetatively, blooming, fertilizing, producing fruits and/or seeds, and harvesting.

In some embodiments, provided is an agricultural composition for controlling growth of one or more plant species comprising: (i) a minicell and (ii) a bioactive agent having herbicidal activity, wherein the bioactive agent is selected from a botanical blend, a metabolite, at least one microbial species, and combinations thereof.

In some embodiments, provided is an agricultural composition for controlling growth of one or more plant species comprising: (i) a minicell and (ii) a bioactive agent having herbicidal activity, wherein the bioactive agent is selected from a botanical blend, a metabolite, at least one microbial species, and combinations thereof.

In other embodiments, provided is a method of controlling growth of one or more plant species, the method comprising: applying an agricultural composition for controlling growth of one or more plant species comprising: (i) a minicell and (ii) a bioactive agent having herbicidal activity, wherein the bioactive agent is selected from a botanical blend, a metabolite, at least one microbial species, and combinations thereof.

In embodiments, the undesirable plant species is negatively controlled, suppressed, inhibited, limited, killed with application of said composition to the plant species.

In further embodiment, the minicell disclosed herein is capable of preserving, enhancing, improving, or extending herbicidal activities of the bioactive agent (i.e. bioherbicides).

In another embodiment, the bioactive agent in the presence of the minicell has at least 1%, at least 2%, at least 3%, at least 4%, at least 5%, at least 6%, at least 7%, at least 8%, at least 9%, at least 10%, at least 11%, at least 12%, at least 13%, at least 14%, at least 15% at least 16%, at least 17%, at least 18%, at least 19%, at least 20%, at least 30%, at least 40%, at least 50% higher herbicidal activity than the bioactive agent alone in the absence of the minicell.

In another embodiment, the bioactive agent in the presence of the minicell has higher herbicidal activity than the bioactive agent alone in the absence of the minicell 1 hour, 2 hours, 3 hours, 4 hours, 5 hours, 6 hours, 12 hours, 18 hours, 24 hours, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 25 days or 30 days after treatment of the agricultural composition or formulation.

The bioactive agent in the presence of the minicell has at least 5% higher herbicidal activity than the bioactive agent alone over a week after treatment. In embodiments, the composition is applied in a liquid form or a soluble, dry powder form.

### Biologically Active Compound Delivery Amounts

In some embodiments, biologically active compounds are encapsulated within the anucleated cells described herein and delivered to a desired target. Amounts of an biologically active compound of interest are provided herein with percent weight proportions of the various components used in the preparation of the anucleated cell for the encapsulation and deliver of biologically active compounds.

The percent weight proportions of the various components used in the preparation of the anucleated cell for the encapsulation and deliver of biologically active compounds can be varied as required to achieve optimal results. In some embodiments, the biologically active compounds including, but are not limited to a nucleic acid, a polypeptide, a metabolite, and a semiochemical, are present in an amount of about 0.1 to about 90% by weight, is present in an amount of about 0.5 to about 80% by weight, 1 to about 70% by weight, 2 to about 60% by weight, 3 to about 55% by weight, 5 to about 50% by weight, 10 to about 45% by weight, and 15 to about 40% by weight, based on the total weight of the anucleated cell within which an active compound of interest is encapsulated. When a polymer is used in the preparation of the anucleated cell disclosed herein, according to one embodiment it is present in an amount of about 0.01 to about 10% by weight based on the total weight of the anucleated cell disclosed herein. When a co-solvent is used in the preparation of the anucleated cell disclosed herein, according to one embodiment it is present in an amount of about 0.1 to about 30% by weight based on the total weight of the anucleated cell disclosed herein. Alternate percent weight proportions are also envisioned. For example, the biologically active compound of interest can be present in an amount of up to about 50% by weight; the solvent can be present in an amount of up to about 70% by weight; the surfactant can be present in an amount of up to about 40% by weight and the water can be present in an amount of from about 1 to about 90% by weight, based on the total weight of the anucleated cell disclosed herein.

Among the various aspects of the present disclosure is an anucleated cell in the form of encapsulation of an biologically active compound of interest at least about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95%, by weight of the biologically active compound within the anucleated cell.

In other embodiments, the biologically active compound within the anucleated cell is present in an amount of at least about 0.01, about 0.02, about 0.03, about 0.04, about 0.05, about 0.06, about 0.07, about 0.08, about 0.09, about 0.1, about 0.2, about 0.3, about 0.4, about 0.5, about 0.6, about 0.7, about 0.8, about 0.9, about 1, about 2, about 3, about 4, about 5, about 6, about 7, about 8, about 9, about 10, about 11, about 12, about 13, about 14, about 15, about 16, about 17, about 18, about 19, about 20, about 30, about 40, about 50, about 60, about 70, about 80, about 90, about 100, about 110, about 120, about 130, about 140, about 150, about 160, about 170, about 180, about 190, about 200, about 300, about 400, about 500 g/L.

In another embodiment, the biologically active compound of interest and the anucleated cell are present in compositions of the disclosure in a weight ratio of at least 1:200, 1:195, 1:190, 1:185, 1:180, 1:175, 1:170, 1:165, 1:160, 1:155, 1:150, 1:145, 1:140, 1:135, 1:130, 1:125, 1:120, 1:115, 1:110, 1:105, 1:100, 1:95, 1:90, 1:85, 1:80, 1:75, 1:70, 1:65, 1:60, 1:55, 1:50, 1:45, 1:40, 1:35, 1:30, 1:25, 1:20, 1:15, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 110:1, 120:1, 130:1, 140:1, 150:1, 160:1, 170:1, 180:1, 190:1 or 200:1. In another embodiment, the biologically active compound of interest and the anucleated cell are present in a weight ratio of from about 1:50 to about 50:1, from about 1:40 to about 40:1, from about 1:30 to about 30:1, from about 1:20 to about 20:1, from about 1:10 to about 10:1, or from about 1:5 to about 5:1.

In another embodiment, the biologically active compound of interest and the anucleated cell are present in compositions of the disclosure in a volume ratio of at least 1:200, 1:195, 1:190, 1:185, 1:180, 1:175, 1:170, 1:165, 1:160, 1:155, 1:150, 1:145, 1:140, 1:135, 1:130, 1:125, 1:120, 1:115, 1:110, 1:105, 1:100, 1:95, 1:90, 1:85, 1:80, 1:75, 1:70, 1:65, 1:60, 1:55, 1:50, 1:45, 1:40, 1:35, 1:30, 1:25, 1:20, 1:15, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 110:1, 120:1, 130:1, 140:1, 150:1, 160:1, 170:1, 180:1, 190:1 or 200:1. In another embodiment, the biologically active compound of interest and the anucleated cell are present in a volume ratio of from about 1:4 to about 4:1. In another embodiment, the biologically active compound of interest and the anucleated cell are present in a volume ratio of from about 1:2 to about 2:1.

In further embodiments, the density of the formulation of the anucleated cell encapsulating the biologically active compound is least 0.01, at least 0.02, at least 0.03, at least 0.04, at least 0.05, at least 0.06, at least 0.07, at least 0.08, at least 0.09, at least 0.1, at least about 0.2, at least about 0.3, at least about 0.4, at least about 0.5, at least about 0.6, at least about 0.7, at least about 0.8, at least about 0.9, at least about 1.0, at least 1.1, at least about 1.2, at least about 1.3, at least about 1.4, at least about 1.5, at least about 1.6, at least about 1.7, at least about 1.8, at least about 1.9, at least about 2.0, at least 2.1, at least about 2.2, at least about 2.3, at least about 2.4, at least about 2.5, at least about 2.6, at least about 2.7, at least about 2.8, at least about 2.9, at least about 3.0, at least 3.1, at least about 3.2, at least about 3.3, at least about 3.4, at least about 3.5, at least about 3.6, at least about 3.7, at least about 3.8, at least about 3.9, at least about 4.0, at least 4.1, at least about 4.2, at least about 4.3, at least about 4.4, at least about 4.5, at least about 4.6, at least about 4.7, at least about 4.8, at least about 4.9, at least about 5.0, at least about 5.5, at least about 6.0, at least about 6.5, at least about 7.0, at least about 7.5, at least about 8.0, at least about 8.5, at least about 9.0, at least about 9.5, at least about 10.0, at least about 11, at least about 12, at least about 13, at least about 14, at least about 15, at least about 16, at least about 17, at least about 18, at least about 19, at least about 20, at least about 30, at least about 40, at least about 50, at least about 60, at least about 70, at least about 80, at least about 90, or at least about 100 grams/liter.

In some embodiments, an biologically active compound of interest, for example, is present in at least about 20% of the total mass of the formulated product. In further embodiments, about 20 to 40% of the total mass of the formulated product is provided for the biologically active compound disclosed herein and the remaining about 60 to 80% of the mass is from the anucleated cell. In embodiments, about 40 to 60% of the total mass of the formulated product is provided for the biologically active compound disclosed herein and the remaining about 40 to 60% of the mass is from the anucleated cell. In further embodiments, about 60 to 80% of the total mass of the formulated product is provided for the biologically active compound disclosed herein and the remaining about 20 to 40% of the mass is from the anucleated cell.

In some embodiments, more than one non-expressed biologically active compounds can be encapsulated within the anucleated cell. In another embodiment, the formulated product comprises two biologically active compounds that are present in compositions of the disclosure in a weight ratio of at least 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, or 10:1.

In terms of amounts of the biologically active compound, about a concentration of about 0.01-500, about 0.1-400, about 0.2-300, about 0.3-200, about 0.3-100, or about 0.5-100 g/L is provided for the formulated product.

In some embodiments, the targeted delivery and controlled release disclosed herein can improve efficacy of the biologically active compounds so that the amounts of the biologically active compound can be used less. The formulation of the anucleated cell-based platform can be in a liquid or solid form. In some embodiments, the formulated product is a liquid form such as a solution. In some embodiments, the formulated product is a solid form such as a powder.

In some embodiments, the agricultural formulation further comprises an agricultural chemical that is useful for promoting plant growth, reducing weeds, or reducing pests. In some embodiments, the agricultural formulation further comprises at least one of a fungicide, an herbicide, a pesticide, a nematicide, an insecticide, a plant activator, a synergist, an herbicide safener, a plant growth regulator, an insect repellant, an acaricide, a molluscicide, or a fertilizer. In some embodiments, the agricultural formulation further comprises a surfactant. In some embodiments, the agricultural formulation further comprises a carrier. The present disclosure provides for agricultural formulations formulated for contacting to plants.

The formulations can be suitable for treating plants or plant propagation material, such as seeds, in accordance with the present disclosure, e.g., in a carrier. Suitable additives include buffering agents, wetting agents, coating agents, polysaccharides, and abrading agents. Exemplary carriers include water, aqueous solutions, slurries, solids and dry powders (e.g., peat, wheat, bran, vermiculite, clay, pasteurized soil, many forms of calcium carbonate, dolomite, various grades of gypsum, bentonite and other clay minerals, rock phosphates and other phosphorous compounds, titanium dioxide, humus, talc, alginate and activated charcoal. Any agriculturally suitable carrier known to one skilled in the art would be acceptable and is contemplated for use in the present invention). Optionally, the formulations can also include at least one surfactant, chemical herbicide, fungicide, pesticide, or fertilizer.

In some embodiments, the agricultural formulation further comprises at least one of a surfactant, a chemical herbicide, a pesticide, such as but not limited to a fungicide, a bactericide, an insecticide, an acaricide, and a nematicide, a plant activator, a synergist, an herbicide safener, a plant growth regulator, an insect repellant, or a fertilizer.

In some embodiments, exemplary chemical herbicides includes, but are not limited to, paraquat, mesotrione, sulcotrione, clomazone, fentrazamide, mefenacet, oxaziclomefone, indanofan, glyphosate, prosulfocarb, molinate, triasulfuron, halosulfuron-methyl, pretilachlor, topramezone, tembotrione, isoxaflutole, fomesafen, clodinafop-propargyl, fluazifop-P-butyl, dicamba, 2,4-D, pinoxaden, bicyclopyrone, metolachlor, and pyroxasulfone. The above herbicidal active ingredients are described, for example, in “The Pesticide Manual”, Editor C. D. S. Tomlin, 12th Edition, British Crop Protection Council, 2000, under the entry numbers added in parentheses; for example, mesotrione (500) is described therein. The above compounds are described, for example, in U.S. Pat. No. 7,338,920, which is incorporated by reference herein in its entirety.

In some embodiments, examplary fungicides include, but are not limited to, sedaxane, fludioxonil, penthiopyrad, prothioconazole, flutriafol, difenoconazole, azoxystrobin, captan, cyproconazole, cyprodinil, boscalid, diniconazole, epoxiconazole, fluoxastrobin, trifloxystrobin, metalaxyl, metalaxyl-M (mefenoxam), fluquinconazole, fenarimol, nuarimol, pyrifenox, pyraclostrobin, thiabendazole, tebuconazole, triadimenol, benalaxyl, benalaxyl-M, benomyl, carbendazim, carboxin, flutolanil, fuberizadole, guazatine, myclobutanil, tetraconazole, imazalil, metconazole, bitertanol, cymoxanil, ipconazole, iprodione, prochloraz, pencycuron, propamocarb, silthiofam, thiram, triazoxide, triticonazole, tolylfluanid, isopyrazam, mandipropamid, thiabendazole, fluxapyroxad, and a manganese compound (such as mancozeb, maneb). In some embodiments, the agricultural chemical formulation comprises an effective amount of one or more of an insecticide, an acaricide and/or nematcide selected from the group consisting of: thiamethoxam, imidacloprid, clothianidin, lamda-cyhalothrin, tefluthrin, beta-cyfluthrin, permethrin, abamectin, fipronil, cyanotraniliprole, chlorantraniliprole, and spinosad. Details (e.g., structure, chemical name, commercial names, etc.) of each of the above pesticides with a common name can be found in the e-Pesticide Manual, version 3.1, 13th Edition, Ed. CDC Tomlin, British Crop Protection Council, 2004-05. The above compounds are described, for example, in U.S. Pat. No. 8,124,565, which is incorporated by reference herein in its entirety.

In some embodiments, further examplary fungicides include, but are not limited to, Cyprodinil ((4-cyclopropyl-6-methyl-pyrimidin-2-yl)-phenyl-amine), Dodine, Chlorothalonil, Folpet, Prothioconazole, Boscalid, Proquinazid, Dithianon, Fluazinam, Ipconazole, and Metrafenone. Some of the above compounds are described, for example, in “The Pesticide Manual” [The Pesticide Manual-A World Compendium; Thirteenth Edition; Editor: C. D. S. Tomlin; The British Crop Protection Council, 2003]. The above compounds are described, for example, in U.S. Pat. No. 8,349,345, which is incorporated by reference herein in its entirety.

In some embodiments, other examplary fungicides includes, but are not limited to, fludioxonil, metalaxyl and a strobilurin fungicide, or a mixture thereof. In some embodiments, the strobilurin fungicide is azoxystrobin, picoxystrobin, kresoxim-methyl, or trifloxystorbin. In some embodiments, the agricultural chemical formulation comprises an effective amount of one or more of an insecticide selected from a phenylpyrazole and a neonicotinoid. In some embodiments, the phenylpyrazole is fipronil and the neonicotinoid is selected from thiamethoxam, imidacloprid, thiacloprid, clothianidin, nitenpyram and acetamiprid. The above compounds are described, for example, in U.S. Pat. No. 7,071,188, which is incorporated by reference herein in its entirety.

In some embodiments, one or more biological pesticide, includes but not limited to, Pasteuria spp., Paeciliomyces, Pochonia chlamydosporia, Myrothecium metabolites, Muscodor volatiles, Tagetes spp., Bacillus firmus, including Bacillus firmus CNCM 1-1582.

### EXAMPLES

The following examples are given for the purpose of illustrating various embodiments of the disclosure and are not meant to limit the present disclosure in any fashion. Changes therein and other uses which are encompassed within the spirit of the disclosure, as defined by the scope of the claims, will occur to those skilled in the art.

### Example 1. Production of AgriCell Minicell (AC) Loaded with Agro Gold (AG)

Fermentation and Purification for Production of AgriCell

In order to produce minicells (AgriCell; AC) for Agro Gold™ (AG) loading test, a minimal media fermentation was conducted and a 2-step centrifugation process was followed to harvest the minicells. The manufacturing process for AgriCell production and purification took approximately 36 hours to produce and recover 20-50 grams dry mass of AgriCell per Liter of fermentation.

Loading process (Loading of AgriCell with AG)

After AgriCells are purified, a test of loading AG to the purified AgriCells was performed. The concentrated AgriCell (AC) paste or dry lyophilized powder is mixed with an equal volume of AG-concentrated solution. The concentrated AC paste (i.e. concentrated AC stock solution) was prepared by dissolving 1 g of dry AC powder in 10 ml of solvent (either PBS or water) to make a concentration of 100 mg/ml AC stock solution/paste. When the concentrated AC paste was used, volume ratio between the concentrated AC paste and AG was kept at 1:1. If the dry lyophilized AgriCells were used, the AgriCells are first homogenized into a finer powder through mechanical homogenization. Lyophilized AgriCells would then be suspended in a solution with the AG solution at a ratio of 1 g of dry AgriCells to 10 mL of AG solution. Once resuspended, the solvent was allowed to evaporate overnight, leaving behind AG-loaded AC in the process. After this overnight period, AG-loaded AgriCells were separated and the AG-loaded AgriCell powder is mechanically homogenized. This AG-loaded AgriCell powder product is ready for resuspension in its appropriate medium.

Loading Test Results

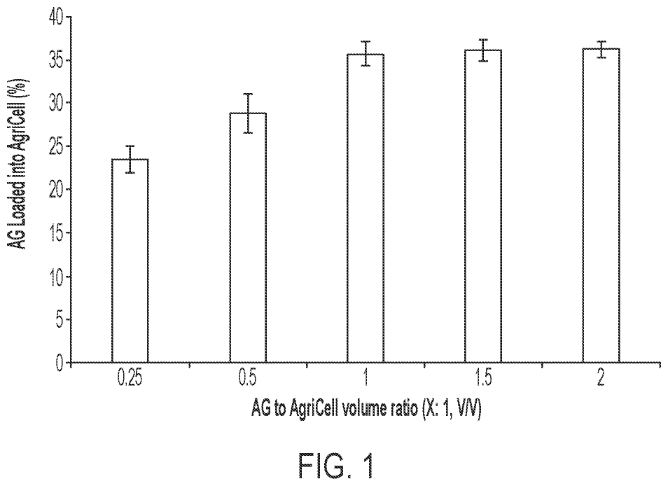

As shown in FIG. 1, loading of AG into AgriCell reaches a maximum loading capacity at a 1:1 volume ratio. 0.25:1 ratio of AG to AC showed about 22-25% of AG loaded into AC and 0.5:1 ratio of AG to AC had about 26%-31% of AG loaded into AC. Volume ratios higher than 1:1 show about the same loading capacity (over 35% of AG loaded into AC) as 1:1 ratio, suggesting a possible saturation of the AgriCell platform loaded with AG.

### Example 2. Controlled Release of Agro Gold (AG) from AgriCell Minicell (AC)

Based on Example 1, release experiments described below were performed using the AG-loaded AgriCell suspensions, which is 1:1 volume ratio of AgriCell and AG solution (100%).

Preparation of AG-Loaded AgriCell Formulations

AG-loaded AgriCell formulations were resuspended in PBS (lx, pH 7.4) and diluted to a known concentration of about 100% AG in release media. Release media was composed by tap water (pH 6.8). Samples were loaded into a dialysis bag (MWCO 10 kD) previously conditioned in deionized water, placed into 250 mL beaker filled with 150 mL of release media and kept under continuous stirring at room temperature.

Quantification of AG Release from AgriCell

Aliquots of 1 mL of release media were removed at different time points (1, 2, 4, 6, 8, 12 and 24 hours) for quantification of released AG performed by UV-vis spectrometry at 310 nm. A new volume of fresh release media was added to continue release experiment. AG released from AgriCell platform was calculated as percentage cumulative release over the selected timeframe. Original content of AG loaded into AgriCell and the remaining content after release studies were quantified by lysing the AgriCell and releasing the encapsulated AG from AgriCell.

Controlled Release of AG from AgriCell

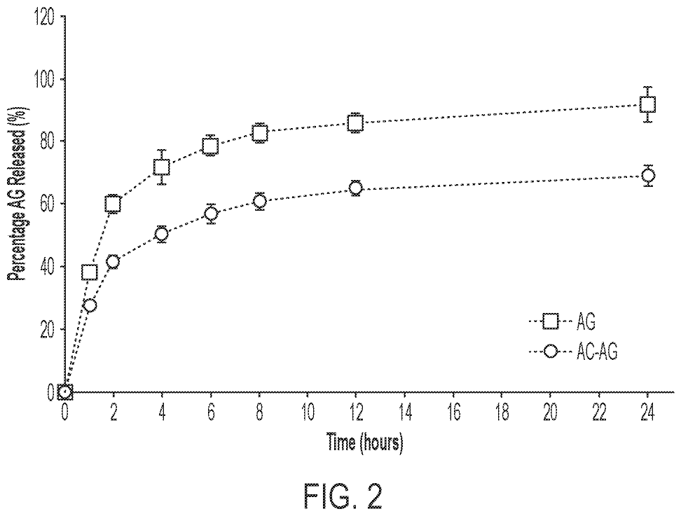

The accumulative release profile of AG was calculated by determining the concentration of AG in the release medium at different time intervals. FIG. 2 shows the AG release profiles for free AG and AG-loaded AgriCell in tap water. Results indicate AG-loaded AgriCell platform can successfully delay burst release stage of AG, when compared to the release rate of free AG. More than 70% of AG was released from free AG that was not loaded onto AgriCell after 4 hours experiment, whereas AG-loaded AgriCell showed only 50% of AG release. The release profiles shown in FIG. 2 continue with a sustained release of AG that trends to reach a steady stage after completing 24 hours of the release experiment, with AG alone reaching more than 90% released and AG-loaded AgriCell reaching lower than 70% released, respectively.

Thus, AgriCell platform can effectively load Agro Gold solution (AG), reaching more than 35% loading capacity at a 1:1 AG to AgriCell volume ratio as shown in FIG. 1. Also, AgriCell can promote controlled release of AG, delaying both burst and steady release stages in about 20%, when compared to free AG release profile as shown in FIG. 2. AgriCell can be a suitable platform for encapsulation and release of bioherbicides (including Agro Gold solution) for herbicidal application, and promote efficient loading capacities and controlled release profiles that will depict in improved stability and in-field performance.

### Example 3. Field Test of Bioherbicides without AgriCell Minicell (AC) Loaded

To test herbicidal effect of Part A (Weed Slayer; WS), Part B (Agro Gold; AG), and a mixture of Parts A and B (WS+AG) on crabgrass and clover, field trials were done in a vineyard located outside of St. Louis, MO. The test plots (3.5 feet×16 feet) in the vineyard were infested mostly with crabgrass and clover. The test plots were randomly designed and prepared. Three treatments, (i) 1× concentration of WS alone, (ii) 1× concentration of AG alone, and (iii) 1× concentration of WS and AG mixture, in triplicate. Concentrates of WS and/or AG were diluted with water and acidified to pH 4.0 with citric acid. 6.2 ml of concentrated WS and/or AG was diluted with water to make 500 ml of the working solution for testing/spraying, as shown in Table 2.

TABLE 2
Compositions of Working Solution without AC

| Test | Rate | Concentrated | Concentrated | Spray Volume |
|---|---|---|---|---|
| Solution | (Concentration) | WS* (mL) | AG (mL) | (mL) |
| WS | 1× | 6.2 | 0 | 500 |
| AG | 1× | 0 | 6.2 | 500 |
| WS + AG | 1× | 6.2 | 6.2 | 500 |

WS*-6% Eugenol

36 hours of rain-free conditions were maintained after spraying 1× working solutions onto the test plots infested with crabgrass and clover. The plots were observed and recorded for herbicidal effect at 8, 15 and 31 days after treatment (DAT).

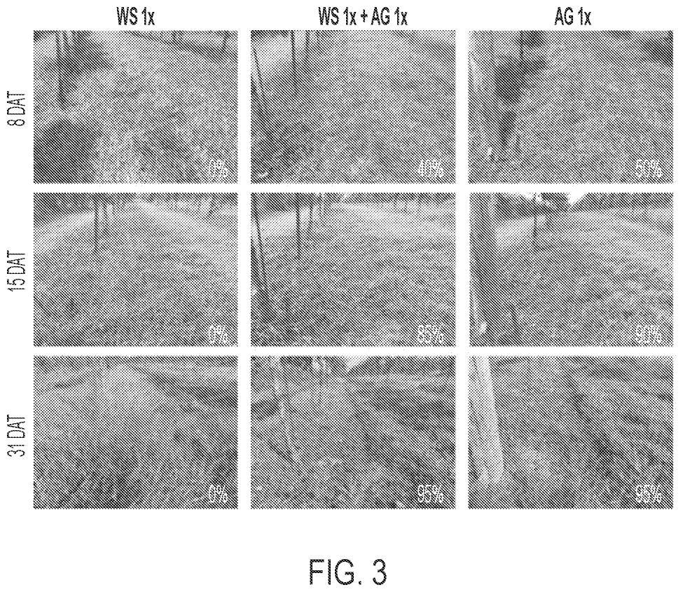

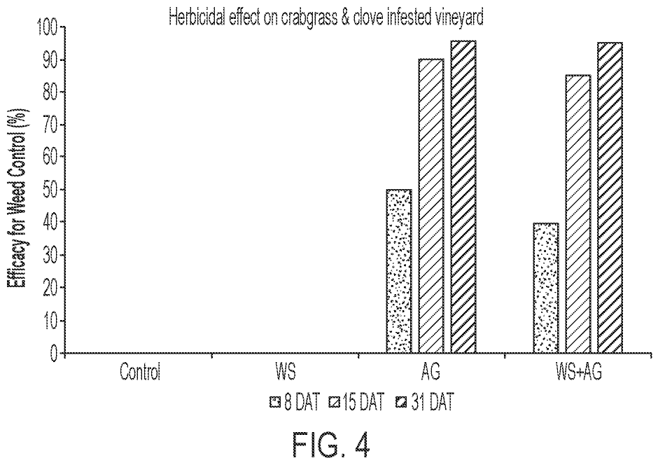

As shown in FIGS. 3 and 4, both treatments, (ii) AG alone and (iii) WS+AG were active on crabgrass and clover. Plot treated with WS+AG solution showed 95% control (i.e. suppression/killing) of crabgrass and clover weeds after 31 DAT. Also, AG-treated plot showed 95% control/suppression/killing of crabgrass and clover weeds after 31 DAT. However, WS-treated plot did not show herbicidal activity against crabgrass and clover.

Results suggest that AG accounts for most of the herbicidal activity in WS+AG, as WS alone showed little to no herbicidal activity on crabgrass and clover weeds.

### Example 4. Field Test of Bioherbicides Loaded with AgriCell Minicell (AC)

To determine herbicidal effect of Agro Gold (AG) alone and in combination with AgriCell (AC) on crabgrass, field test were performed in a vineyard located outside of St. Louis, MO. The test plots (1.75 feet×8 feet) in the vineyard were infested with crabgrass. The test plots were randomly designed and prepared. Four treatments, (i) 1× concentration of WS alone, (ii) 1× concentration of WS and AG mixture, (iii) 1× concentration of AG alone, and (iv) 1× concentration of AG and AgriCell (AC) mixture, in triplicate. Concentrates of WS and/or AG were diluted with water and acidified to pH 4.0 with citric acid. 3.1 ml of concentrated WS and/or AG was diluted with water to make 250 ml of the working solution for testing/spraying. Also, 3.1 ml of AC solution was added with 3.1 ml of AG solution to make 250 ml of working solution of AC+AG, as shown in Table 3.

TABLE 3
Compositions of Working Solution with AC loaded

| | Rate | Concen- | Concen- | Concen- | Spray |
|---|---|---|---|---|---|
| Test | (Concen- | trated | trated | trated | Volume |
| Solution | tration) | WS* (mL) | AG (mL) | AC* (mL) | (mL) |
| WS | 1× | 3.1 | 0 | 0 | 250 |
| WS + AG | 1× | 3.1 | 3.1 | 0 | 250 |
| AG | 1× | 0 | 3.1 | 0 | 250 |
| AC + AG | 1× | 0 | 3.1 | 3.1 | 250 |

WS*-6% Eugenol
AC*-100 mg/mL (1 g of AC in 10 mL solvent (PBS or water))

36 hours of rain-free conditions were maintained after spraying 1× working solutions onto the test plots infested with crabgrass. The plots were observed and recorded for herbicidal effect at 6 and 15 days after treatment (DAT).

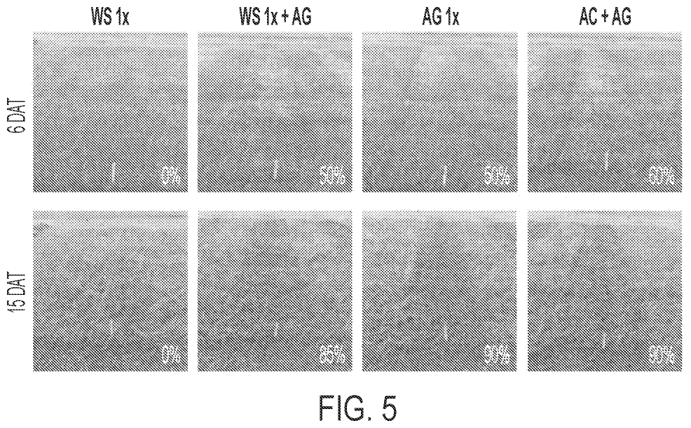

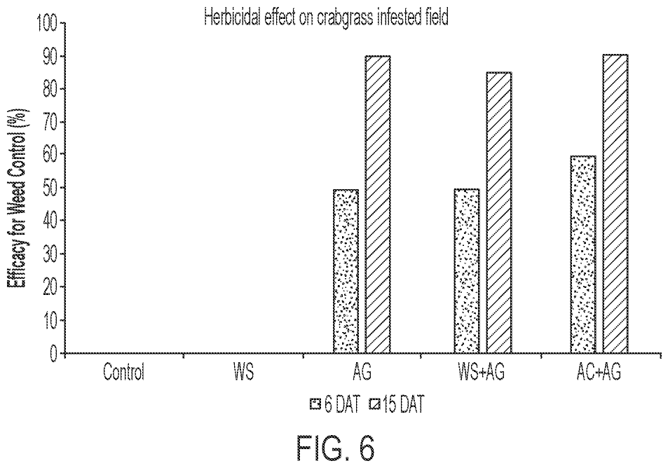

As shown in FIGS. 5 and 6, three treatments, (ii) WS+AG, (iii) AG alone and (iv) AC+AG were active on crabgrass weeds. Plots treated with (ii) WS+AG solution and (iii) AG alone showed 50% control (i.e. suppression and/or killing) of crabgrass weeds after 6 DAT, respectively. Instead, plot treated with (iv) AC+AG showed 60% control/suppression/killing of crabgrass weeds after 6 DAT, which is 10% higher than the other two treatments that were active to crabgrass. Like Example 3, WS-treated plot did not show herbicidal activity against crabgrass.

After 15 DAT, WS-treated plot still showed little to no activity against crabgrass. From plot treated with WS+AG, 85% of crabgrass weeds were controlled, suppressed and/or killed after 15 DAT. On the other hand, AG-treated plot showed 90% control of crabgrass weeds, as well as plot treated with AC+AG showed 90% control of crabgrass after 15 DAT.

From this field test, it is suggested that AC enhances herbicidal activity of AG at initial stages.

### Example 5. Green House Test of Bioherbicides Loaded with AgriCell Minicell (AC)

To understand how WS and AG work as bioherbicides in combination with AgriCell (AC) on mustard grass, green house tests were performed on plots (3 inches×9 inches) growing mustard grass. The test beds were randomly designed and prepared. Six treatments, (i) water control (No WS, AG, and AC added), (ii) 1× concentration of WS alone, (iii) 1× concentration of WS and AG mixture, (iv) 1× concentration of AG alone, (v) 1× concentration of AG and AgriCell (AC) mixture, and (vi) AC+Eugenol, in triplicate. Concentrates of WS and/or AG were diluted with water and acidified to pH 6.8. 0.62 ml of concentrated WS and/or AG was diluted with water to make 50 ml of the working solution for testing/spraying. Also, 0.62 ml of AC solution was added with 0.62 ml of AG solution to make 50 ml of working solution of AC+AG, as shown in Table 4.

TABLE 4
Compositions of Working Solution with AC loaded

| | | | | | | Spray |
|---|---|---|---|---|---|---|
| Test | Rate | Concentrated | Concentrated | Concentrated | 6% | Volume |
| Solution | (Concentration) | WS* (mL) | AG (mL) | AC (mL) | Eugenol | (mL) |
| WS | 1x | 0.62 | 0 | 0 | 0 | 50 |
| WS + AG | 1x | 0.62 | 0.62 | 0 | 0 | 50 |
| AG | 1x | 0 | 0.62 | 0 | 0 | 50 |
| AC + AG | 1x | 0 | 0.62 | 0.62 | 0 | 50 |
| AC + Eugenol | 1x | 0 | 0 | 0.62 | 0.62 | 50 |

WS*—6% Eugenol
AC*—100 mg/mL (1 g of AC in 10 mL solvent (PBS or water))

36 hours of rain-free conditions were maintained after spraying 1× working solutions onto the test plots infested with mustard grass. The plots were observed and recorded for herbicidal effect at 4, 8, and 15 days after treatment (DAT).

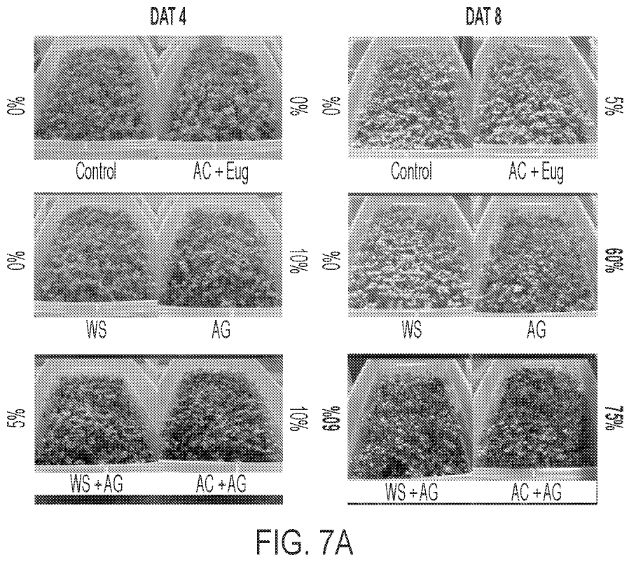

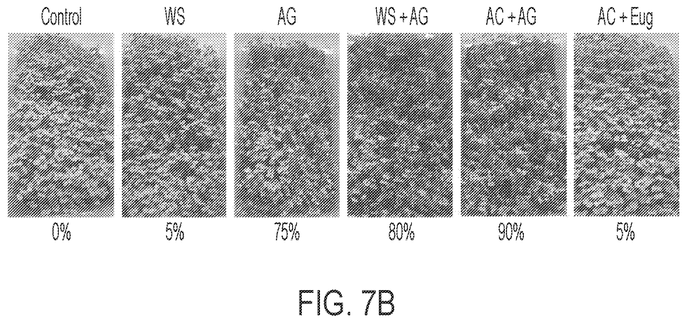

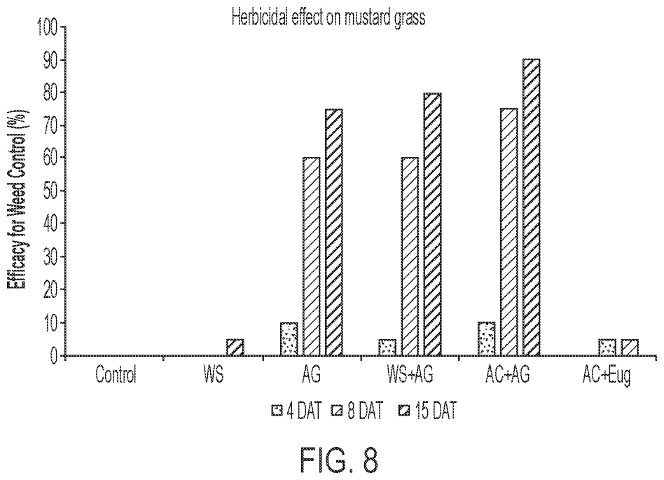

As shown in FIGS. 7A-7B and 8, three treatments, (iii) WS+AG, (iv) AG alone and (v) AC+AG were active on mustard grass weeds. Plots treated with (iii) WS+AG solution and (iv) AG alone showed 60% control (i.e. suppression and/or killing) of mustard grass weeds after 8 DAT, respectively. Instead, plot treated with (v) AC+AG showed 75% control/suppression/killing of mustard grass weeds after 8 DAT, which is 15% higher than the other two treatments that were active to mustard grass.

Plots treated with (i) WS alone and (vi) AC+Eugenol showed little to no activity against mustard grass after 15 DAT. From plot treated with WS+AG, 75% of mustard grass weeds were controlled, suppressed and/or killed after 15 DAT. AG-treated plot showed 80% control of mustard grass weeds. Lastly, plot treated with AC+AG showed 90% control of mustard grass after 15 DAT.

This green house test results also confirm that AC enhances herbicidal activity of AG at initial stages like Example 4.

Although the foregoing disclosure has been described in some detail by way of illustration and examples, which are for purposes of clarity of understanding, it will be apparent to those skilled in the art that certain changes and modifications may be practiced without departing from the spirit and scope of the disclosure, which is delineated in the appended claims. Therefore, the description should not be construed as limiting the scope of the disclosure.

### NUMBERED EMBODIMENTS OF THE DISCLOSURE

Notwithstanding the appended claims, the disclosure sets forth the following numbered embodiments:
1. An agricultural composition for controlling growth of one or more plant species comprising: a bioactive agent having herbicidal activity, wherein the bioactive agent is selected from a botanical blend, a metabolite, at least one microbial species, and combinations thereof; and wherein the growth of the plant species is controlled with application of said composition to the plant species.
2. The agricultural composition of embodiment 1, wherein said botanical blend is a plant extract or oil having a herbicidal activity.
3. The agricultural composition of any one of embodiments 1-2, wherein said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound.
4. The agricultural composition of any one of embodiments 1-3, wherein said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof.
5. The agricultural composition of any one of embodiments 1-4, wherein said microbial species is selected from a Streptomyces genus, an Actinomyces genus, a Bacillus genus and a Pseudomonas genus.
6. The agricultural composition of any one of embodiments 1-5, wherein said microbial species is Streptomyces rimosus or Bacillus megaterium.
7. The agricultural composition of any one of embodiments 1-6, wherein the composition is applied in a liquid form or a soluble, dry powder form.
8. The agricultural composition of any one of embodiments 1-7, wherein an effective amount of the bioactive agent is determined for application of the agricultural composition.
9. The agricultural composition of any one of embodiments 1-8, wherein the composition is applied at an effective rate.
10. The agricultural composition of any one of embodiments 1-9, wherein the plant species is selected from crabgrass, clover, mustard, wild mustard, dandelion, black medic, bellflower, daisy, plantain, Bermuda grass, blue grass, and Canadian thistle.
11. The agricultural composition of any one of embodiments 1-10, wherein the plant species is selected from crabgrass, clover and mustard.
12. An agricultural composition for controlling growth of one or more plant species comprising:
   (i) a minicell and (ii) a bioactive agent having herbicidal activity, wherein the bioactive agent is selected from a botanical blend, a metabolite, at least one microbial species, and combinations thereof; and
   wherein the growth of the plant species is controlled with application of said composition to the plant species, and
   wherein the minicell enhances herbicidal activity of the bioactive agent.
13. The agricultural composition of embodiment 12, wherein the minicell is an achromosomal bacterial cell.
14. The agricultural composition of any one of embodiments 12-13, wherein the minicell is capable of encapsulating the bioactive agent and wherein the bioactive agent is present within the minicell.
15. The agricultural composition of any one of embodiments 12-14, wherein said botanical blend is a plant extract or oil having a herbicidal activity.
16. The agricultural composition of any one of embodiments 12-15, wherein said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound.
17. The agricultural composition of any one of embodiments 12-16, wherein said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof.
18. The agricultural composition of any one of embodiments 12-17, wherein said microbial species is selected from a Streptomyces genus, an Actinomyces genus, a Bacillus genus and a Pseudomonas genus.
19. The agricultural composition of any one of embodiments 12-18, wherein said microbial species is Streptomyces rimosus or Bacillus megaterium.
20. The agricultural composition of any one of embodiments 12-19, wherein the composition is applied in a liquid form or a soluble, dry powder form.
21. The agricultural composition of any one of embodiments 12-20, wherein an effective amount of the bioactive agent is determined for application of the agricultural composition.
22. The agricultural composition of any one of embodiments 12-21, wherein the composition is applied at an effective rate.
23. The agricultural composition of any one of embodiments 12-22, wherein a mixture ratio of the bioactive agent and the minicell is from 1:4 to 4:1 in volume to volume.
24. The agricultural composition of any one of embodiments 12-23, wherein the plant species is selected from crabgrass, clover, mustard, wild mustard, dandelion, black medic, bellflower, daisy, plantain, Bermuda grass, blue grass, and Canadian thistle.
25. The agricultural composition of any one of embodiments 12-24, wherein the plant species is selected from crabgrass, clover and mustard.
26. The agricultural composition of embodiment 12, wherein the bioactive agent in the presence of the minicell has at least 5% higher herbicidal activity than the bioactive agent alone over a week after treatment.
27. A method of controlling growth of one or more plant species, the method comprising: applying an effective amount of an agricultural composition to a plant or a part thereof, wherein said composition comprises a bioactive agent having herbicidal activity, wherein the bioactive agent is selected from a botanical blend, a metabolite, at least one microbial species, and combinations thereof; and wherein the growth of the plant species is controlled with said application of the composition.
28. The method of embodiment 27, wherein said composition is applied to any portion of said plant or said part thereof.
29. The method of any one of embodiments 27-28, wherein said composition is applied to a root system of said plant or said part thereof.
30. The method of any one of embodiments 27-29, wherein said botanical blend is a plant extract or oil having a herbicidal activity.
31. The method of any one of embodiments 27-30, wherein said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound.
32. The method of any one of embodiments 27-31, wherein said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromycin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof.
33. The method of any one of embodiments 27-32, wherein said microbial species is selected from a Streptomyces genus, an Actinomyces genus, a Bacillus genus and a Pseudomonas genus.
34. The method of any one of embodiments 27-33, wherein said microbial species is Streptomyces rimosus or Bacillus megaterium.
35. The method of any one of embodiments 27-34, wherein the composition is applied in a liquid form or a soluble, dry powder form.
36. The method of any one of embodiments 27-35, wherein an effective amount of the bioactive agent is determined for application of the agricultural composition.
37. The method of any one of embodiments 27-36, wherein the composition is applied at an effective rate.
38. The method of any one of embodiments 27-37, wherein the plant species is selected from crabgrass, clover, mustard, wild mustard, dandelion, black medic, bellflower, daisy, plantain, Bermuda grass, blue grass, and Canadian thistle.
39. The method of any one of embodiments 27-38, wherein the plant species is selected from crabgrass, clover and mustard.
40. A method of controlling growth of one or more plant species, the method comprising: applying an effective amount of an agricultural composition for controlling growth of one or more plant species comprising:
   (i) a minicell and (ii) a bioactive agent having herbicidal activity, wherein the bioactive agent is selected from a botanical blend, a metabolite, at least one microbial species, and combinations thereof; and
   wherein the growth of the plant species is controlled with said application of the composition and wherein the minicell enhances herbicidal activity of the bioactive agent.
41. The method of embodiment 40, wherein the minicell is an achromosomal bacterial cell.
42. The method of any one of embodiments 40-41, wherein the minicell is capable of encapsulating the bioactive agent and wherein the bioactive agent is present within the minicell.
43. The method of any one of embodiments 40-42, wherein said composition is applied to any portion of said plant or said part thereof.
44. T The method of any one of embodiments 40-43, wherein said composition is applied to a root system of said plant or said part thereof.
45. The method of any one of embodiments 40-44, wherein said botanical blend is a plant extract or oil having a herbicidal activity.
46. The method of any one of embodiments 40-45, wherein said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound.
47. The method of any one of embodiments 40-46, wherein said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromvcin, N-Phenylpropanamide, N-(naphthalene-1-yl)propenamide, Thienodolin, Isoxazol-4-carboxylic acid, Phthoxazolins, Inthomycins. Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof.
48. The method of any one of embodiments 40-47, wherein said microbial species is selected from a Streptomyces genus, an Actinomyces genus, a Bacillus genus and a Pseudomonas genus.
49. The method of any one of embodiments 40-48, wherein said microbial species is Streptomyces rimosus or Bacillus megaterium.
50. The method of any one of embodiments 40-49, wherein the composition is applied in a liquid form or a soluble, dry powder form.
51. The method of any one of embodiments 40-50, wherein an effective amount of the bioactive agent is determined for application of the agricultural composition.
52. The method of any one of embodiments 40-51, wherein the composition is applied at an effective rate.
53. The method of any one of embodiments 40-52, wherein a mixture ratio of the bioactive agent and the minicell is from 1:4 to 4:1 in volume to volume.
54. The method of any one of embodiments 40-53, wherein the plant species is selected from crabgrass, clover, mustard, wild mustard, dandelion, black medic, bellflower, daisy, plantain, Bermuda grass, blue grass, and Canadian thistle.
55. The method of any one of embodiments 40-54, wherein the plant species is selected from crabgrass, clover and mustard.
56. The method composition of embodiment 40, wherein the bioactive agent in the presence of the minicell has at least 5% higher herbicidal activity than the bioactive agent alone over a week after treatment.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world.

### REFERENCES

AgroSpheres, Inc. Compositions and methods for enzyme immobilization, PCT/US2018/030328
AgroSpheres, Inc. Compositions and methods for the encapsulation and scalable delivery of agrochemicals, PCT/US2018/030329
POURTAHERI P., ZOMORODI S., DAVIS Z. G., SHAKEEL A. M., Frank J., MOSHASHA S. R., KHOKHLACHEV A., Kester M., Compositions and methods for pesticide degradation, WO2017/180650 A1
Marja Koivunen, Pamela Marrone, Uses of thaxtomin and thaxtomin compositions as herbicides, U.S. Pat. No. 8,822,381B2
Huazhang Huang, Ratnakar Asolkar, Pamela Marrone, Plant glutamine synthetase inhibitors and methods for their identification, WO2014088697A2
Takeshi Murakami, Satoshi Imai, Hiroyuki Anzai, Atsuyuki Satoh, Kozo Nagaoka, Bialaphos producing gene, EP0173327B1
Justin M. Lira, Terry R. Wright, Timothy D. Hey, Tonya Strange Moynahan, Lisa W. Baker, Constructs for expressing herbicide tolerance genes, related plants, and related trait combinations, EP2299804A2
Tai Choon Kuah, Soon Huat Ooi, Gill Jagdish Singh, Daniel Anthonysamy, Synergistic herbicidal agents based on leaf herbicides containing phosphorus, imidazolinones and hormone weed-killers, WOl999052367AI
Leonard Katz, Lu Liu, Loleta M. Chung, Recombinant Streptomyces hygroscopicus host cells that produce 17-desmethylrapamycin, U.S. Pat. No. 6,670,168B1
Xiujie LiMichelle Sulz, Natural herbicide, US20070191228A1
Marc Lajeunesse, Herbicide composition for use in killing one or more plant species, US20190350206A1
Nengbing Tao, Methods and compositions for weed control, U.S. Ser. No. 10/609,930B2 Bo A B, Kim J D, Kim Y S, Sin H T, Kim H J, Khaitov B, et al. (2019) Isolation, identification and characterization of Streptomyces metabolites as a potential bioherbicide. PLoS ONE 14(9): e0222933.
Shi L et al., (2020) Herbicidal Secondary Metabolites from Actinomycetes: Structure Diversity, Modes of Action, and Their Roles in the Development of Herbicides, J. Agric. Food Chem. 68: 17-32

What is claimed is:

1. An agricultural composition for controlling growth of one or more plant species comprising:
(i) a minicell and (ii) a bioactive agent having herbicidal activity,
wherein the bioactive agent is selected from a botanical blend, a metabolite, at least one microbial species, and combinations thereof; and
wherein the growth of the plant species is controlled with application of said composition to the plant species, and
wherein the minicell enhances herbicidal activity of the bioactive agent.

2. The agricultural composition of claim 1, wherein the minicell is an achromosomal bacterial cell.

3. The agricultural composition of any one of claims 1-2, wherein the minicell is capable of encapsulating the bioactive agent and wherein the bioactive agent is present within the minicell.

4. The agricultural composition of any one of claims 1-3, wherein said botanical blend is a plant extract or oil having a herbicidal activity.

5. The agricultural composition of any one of claims 1-4, wherein said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound.

6. The agricultural composition of any one of claims 1-5, wherein said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromvcin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof.

7. The agricultural composition of any one of claims 1-6, wherein said microbial species is selected from a Streptomyces genus, an Actinomyces genus, a Bacillus genus and a Pseudomonas genus.

8. The agricultural composition of any one of claims 1-7, wherein said microbial species is Streptomyces rimosus or Bacillus megaterium.

9. The agricultural composition of any one of claims 1-8, wherein the composition is applied in a liquid form or a soluble, dry powder form.

10. The agricultural composition of any one of claims 1-9, wherein a mixture ratio of the bioactive agent and the minicell is from 1:4 to 4:1 in volume to volume.

11. The agricultural composition of any one of claims 1-10, wherein the plant species is selected from crabgrass, clover, mustard, wild mustard, dandelion, black medic, bellflower, daisy, plantain, Bermuda grass, blue grass, and Canadian thistle.

12. The agricultural composition of any one of claims 1-11, wherein the plant species is selected from crabgrass, clover and mustard.

13. The agricultural composition of claim 1, wherein the bioactive agent in the presence of the minicell has at least 5% higher herbicidal activity than the bioactive agent alone over a week after treatment.

14. A method of controlling growth of one or more plant species, the method comprising: applying an agricultural composition for controlling growth of one or more plant species comprising:
(i) a minicell and (ii) a bioactive agent having herbicidal activity,
wherein the bioactive agent is selected from a botanical blend, a metabolite, at least one microbial species, and combinations thereof; and
wherein the growth of the plant species is controlled with said application of the composition and wherein the minicell enhances herbicidal activity of the bioactive agent.

15. The method of claim 14, wherein the minicell is an achromosomal bacterial cell.

16. The method of any one of claims 14-15, wherein the minicell is capable of encapsulating the bioactive agent and wherein the bioactive agent is present within the minicell.

17. The method of any one of claims 14-16, wherein said composition is applied to any portion of said plant or said part thereof.

18. T The method of any one of claims 14-17, wherein said composition is applied to a root system of said plant or said part thereof.

19. The method of any one of claims 14-18, wherein said botanical blend is a plant extract or oil having a herbicidal activity.

20. The method of any one of claims 14-19, wherein said metabolite is an amino acid, a peptide, a nucleoside and its analogue, an acyclic and cyclic ester, an organic acid, an amide, an ozazole-containing metabolite, an antraquinone, an ansamycin, or a non-classified herbicidal compound.

21. The method of any one of claims 14-20, wherein said metabolite is selected from the group of consisting of L-2-amino-4-(2-amino ethoxy)-trans-3-butenoic acid, Alpha-methylene-beta-amino-propanoic acid, 4-Chlorothreonine, Homoalanosine, Pyridazocidin, Acivicin, Gostatin, Gabaculine, L-1,4-cyclohexadiene-1-alanine, cis-L-2-amino-1-hydroxycyclobutane-1-acetic acid, Oxetin (2R,3S)-3-aminooxetane-2-carboxylic acid), Bialaphos, Phosalacine, Trialaphos, Phosphonothricin, Plumbemycins, γ-Glutamyl-methionine sulfoximine (γ-Glu MSO), L-(N5-Phosphono)methionine-S-sulfoximinyl-L-alanyl-L-alanine, Resormycin, Rotihibins, Actinonin, 2,5-diketopiperazine thaxtomins, Thaxtomin A, Eponemycin, Eporpomycin, Nebularine, Coaristeromycin, Ara-A, Albucidin, Coformycin, 5′-Deoxytoyocamycin, Toyocamycin, Tubercidin, 5′-O-Sulfamoyltubercidin, Sangivamycin, Dealanylascamycin, Herbicidins, Hydantocidin, Blasticidin S and 5-hydroxylmethyl-blasticidin S, Phthoramycin, Kaimonolides, Bafilomycins, Borrelidin, Yokonolides, Vulgamycin, Pironetin, Diethyl 7-hydroxytriedeca-2,5,8,11-tetraenedioate, 1-Hydroxy-4-methoxy-naphthoic acid, Pyrrol-2-carboxylic acid, Fosmidomycin, Pteridic acids, Maduramycin, Nigericin, Monensin, Laidlomycin, Herboxidiene, Streptimidones, Cycloheximide, Naramycin B, Methoxhygromvcin, N-Phenylpropanamide, N-(naphthalene-1-yl)propenamide, Thienodolin, Isoxazol-4-carboxylic acid, Phthoxazolins, Inthomycins, Oxazolomyin, Yanglingmycin, Hydranthomycin, Herbimycins, Geldanamycin, Abenquines, Flavonoids, Gliricidin, Chrysin and Tectichrysin, Anisomycin (Methoxyphenone), Streptol, Caerulomycin, and combinations thereof.

22. The method of any one of claims 14-21, wherein said microbial species is selected from a Streptomyces genus, an Actinomyces genus, a Bacillus genus and a Pseudomonas genus.

23. The method of any one of claims 14-22, wherein said microbial species is Streptomyces rimosus or Bacillus megaterium.

24. The method of any one of claims 14-23, wherein the composition is applied in a liquid form or a soluble, dry powder form.

25. The method of any one of claims 14-24, wherein a mixture ratio of the bioactive agent and the minicell is from 1:4 to 4:1 in volume to volume.

26. The method of any one of claims 14-25, wherein the plant species is selected from crabgrass, clover, mustard, wild mustard, dandelion, black medic, bellflower, daisy, plantain, Bermuda grass, blue grass, and Canadian thistle.

27. The method of any one of claims 14-26, wherein the plant species is selected from crabgrass, clover and mustard.

28. The method composition of claim 14, wherein the bioactive agent in the presence of the minicell has at least 5% higher herbicidal activity than the bioactive agent alone over a week after treatment.
